(19) United States
(12) Patent Application Publication
(10) Pub. No.: US 2024/0384050 A1
(43) Pub. Date: Nov. 21, 2024

(54) SHAPED FLEXIBLE PU FOAM ARTICLES

(71) Applicant: Evonik Operations GmbH, Essen (DE)

(72) Inventors: Daniela HERMANN, Düsseldorf (DE); Robert BORGOGELLI, Macungie, PA (US); Annegret TERHEIDEN, Alpen (DE)

(73) Assignee: Evonik Operations GmbH, Essen (DE)

(21) Appl. No.: 18/569,398

(22) PCT Filed: Jun. 9, 2022
(86) PCT No.: PCT/EP2022/065650

§ 371 Date: Dec. 12, 2023

Related U.S. Application Data
(60) Provisional application No. 63/211,799, filed on Jun. 17, 2021.

(51) Int. Cl. C08J 9/00; A47C 7/18; A47C 27/14; B65B 63/02; C08G 18/18; C08G 18/24; C08G 18/48; C08G 18/76; C08G 101/00

(52) U.S. Cl. CPC C08J 9/0042; A47C 7/18; A47C 27/14; B65B 63/028; C08G 18/1825; C08G 18/244; C08G 18/4829; C08G 18/7621; C08G 2101/00; C08G 2110/0008; C08G 2110/0083; C08J 2375/08

(57) ABSTRACT

A shaped flexible hot-cure PU foam article, preferably mattress and/or cushion, may be obtained by reaction of at least one polyol component and at least one isocyanate component in the presence of at least one blowing agent and one or more catalysts that catalyze the isocyanate-polyol and/or isocyanate-water reactions and/or isocyanate trimerization, foam stabilizer, and further additives. The foam stabilizer may include at least one compound of formula (1)

[R¹₂R²SiO_{1/2}]ₐ[R¹₃SiO_{1/2}]_{b}[R¹₂SiO_{2/2}]_{c}[R¹R²SiO_{2/2}]_{d}[R³SiO_{3/2}]ₑ[SiO_{4/2}]_{f}G_{g} (1).

The present invention is in the field of polyurethane (PU) foams. It especially relates to the provision of shaped hot-cure flexible PU foam articles, for example mattresses and/or cushions.

Shaped flexible PU foam articles, for example flexible PU foam-containing mattresses and/or cushions, have long been known from the prior art and are employed worldwide. There has been no shortage of attempts to achieve ever greater improvements. The need for optimization has not been fully satisfied to the present day.

One problem with regard to shaped flexible PU foam articles is the transport and storage thereof. Shaped flexible PU foam articles, for example mattresses, are very bulky and are therefore often compressed, especially compressed and vacuum-packed, for storage and transport due to space considerations. Large distributors are increasingly shipping certain mattresses in compressed and rolled-up form.

Such packagings are widely used for mattresses in particular. In vacuum packaging the mattress is placed in a bag made of plastic film for example. The thus prepackaged mattress is then placed in a press and compressed with one end of the bag open. The air escapes. The open end of the bag is then welded shut in an airtight manner. The thus obtained vacuum packaging is then rolled up and placed inside an outer bag. The mattress cannot re-expand since the outer bag keeps it in rolled-up form.

Flattening a mattress to the extent achieved by a machine during rolling for example requires a force between 40 000 and 250 000 N depending on the mattress. This corresponds to the weight exerted by a mass of 4 to 25 tons.

As is immediately apparent, such a force in connection with the compression of shaped flexible PU foam articles may result in material fatigue. It is a very relevant problem to provide shaped flexible PU foam articles which even after extended compression are capable of recovering their original dimensions.

Against this backdrop the present invention specifically has for its object to provide shaped flexible PU foam articles such as in particular flexible PU foam-containing mattresses and/or cushions that have good capability of recovering their original shape after compression over a period of at least 20 hours.

In the context of the present invention it has now been found that, surprisingly, this object can be achieved by the subject matter of the invention.

This invention provides a shaped flexible hot-cure PU foam article, preferably mattress and/or cushion, wherein the hot-cure flexible PU foam has been obtained by reaction of at least one polyol component and at least one isocyanate component in the presence of at least one blowing agent and one or more catalysts that catalyze the isocyanate-polyol and/or isocyanate-water reactions and/or isocyanate trimerization, foam stabilizer and optional further additives, characterized in that the foam stabilizer comprises at least one compound of formula (1):

[R¹₂R²SiO_{1/2}]ₐ[R¹₃SiO_{1/2}]_{b}[R¹₂SiO_{2/2}]_{c}[R¹R²SiO_{2/2}]_{d}[R³SiO_{3/2}]ₑ[SiO_{4/2}]_{f}G_{g} Formula (1)
with
a=0 to 12, preferably 0 to 10, more preferably 0 to 8
b=0 to 8, preferably 0 to 6, more preferably 0 to 2
c=15 to 300, preferably 40 to 200, more preferably 45 to 120
d=0 to 40, preferably 0 to 30, more preferably 2 to 20
e=0 to 10, preferably 0 to 8, more preferably 0 to 6
f=0 to 5, preferably 0 to 3, more preferably 0
g=>0 to 3, preferably 0.1 to 2.5, more preferably 0.2 to 2
where:
a+b+c+d+e+f+g>23, preferably >40, more preferably >50
a+b≥2
a+d≥1
G=independently same or different bridging groups according to formula (2)

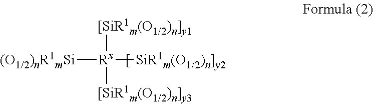

with
R^{x}=independently same or different linear or branched, saturated or unsaturated organic or Si containing radicals
m=independently 1 or 2
n=independently 1 or 2
n+m=3
y1, y2, y3=independently 0 or 1
y1+y2+y3>0 to 3, preferably >0.25 to 3, more preferably >0.5 to 3
where:
R¹=same or different radicals, selected from the group of alkyl radicals having 1-16 carbon atoms or aryl radicals having 6-16 carbon atoms or hydrogen or —OR⁵, saturated or unsaturated, preferably methyl, ethyl, octyl, dodecyl, phenyl or hydrogen, more preferably methyl or phenyl
R²=independently identical or different polyethers of the general formula (3) obtainable from the polymerization of ethylene oxide, propylene oxide and/or other alkylene oxides such as butylene oxide or styrene oxide or an organic radical according to formula (4)

—R⁴—O—[C₂H₄O]ᵢ—[C₃H₆O]ⱼ—[CR⁶₂CR⁶₂O]ₖ—R⁷ Formula (3)

—Oₕ—R⁸ Formula (4)
where
h=0 or 1
i=0 to 150, preferably 1 to 100, more preferably 1 to 80
j=0 to 150, preferably 0 to 100, more preferably 0 to 80
k=0 to 80, preferably 0 to 40, more preferably 0
p=1-18, preferably 1-10, more preferably 3 or 4
where
i+j+k≥3
R³=same or different radicals, selected from the group of alkyl or aryl radicals, saturated or unsaturated, unsubstituted or substituted with hetero atoms, preferably alkyl radicals having 1-16 carbon atoms or aryl radicals having 6-16 atoms, saturated or unsaturated, unsubstituted or substituted with halogen atoms, more preferably methyl, vinyl, chlorpropyl or phenyl
R⁴=divalent organic radical, preferably a divalent organic alkyl or aryl radical, optionally substituted with —OR⁵, more preferably a divalent organic radical of type CₚH₂ₚ
R⁵=same or different radicals, selected from the group of alkyl radicals having 1-16 carbon atoms or aryl radicals having 6-16 carbon atoms, saturated or unsaturated, or hydrogen, preferably alkyl radicals having 1-8 carbon atoms, saturated or unsaturated, or hydrogen, more preferably methyl, ethyl, isopropyl or hydrogen
R⁶=same or different radicals, selected from the group of alkyl radicals having 1-18 carbon atoms, and optionally bearing ether functions or substitution with halogen atoms, or aryl radicals having 6-18 carbon atoms and optionally bearing ether functions, or hydrogen, preferably alkyl radicals having 1-12 carbon atoms, and optionally bearing ether functions or substitution with halogen atoms, or aryl radicals having 6-12 carbon atoms and optionally bearing ether functions, or hydrogen, more preferably hydrogen, methyl, ethyl or benzyl
R⁷=same or different radicals, selected from the group of hydrogen, alkyl, —C(O)—R⁹, —C(O)O—R⁸ or —C(O)NHR⁹, saturated or unsaturated, optionally substituted with hetero atoms, preferably hydrogen, alkyl having 1-8 carbon atoms or acetyl, more preferably hydrogen, methyl, acetyl or butyl
R⁸=same or different radicals, selected from the group or alkyl radicals or aryl radicals, saturated or unsaturated, and optionally bearing one or more OH, ether, epoxide, ester, amine or/and halogen substituents, preferably alkyl radicals having 1-18 carbon atoms or aryl radicals having 6-18 carbon atoms, saturated or unsaturated, and optionally bearing one or more OH, ether, epoxide, ester, amine or/and halogen substituents, more preferably alkyl radicals having 1-18 carbon atoms or aryl radicals having 6-18 carbon atoms, saturated or unsaturated, bearing at least one substituent selected of the group of OH, ether, epoxide, ester, amine or/and halogen substituents
R⁹=same or different radicals, selected from the group of alkyl radicals having 1-16 carbon atoms or aryl radicals having 6-16 carbon atoms, saturated or unsaturated, preferably alkyl radicals having 1-8 carbon atoms, or aryl radicals having 6-12 carbon atoms, saturated or unsaturated, more preferably methyl, ethyl, butyl or phenyl.

For the description of the siloxanes a notation analogous to the literature is chosen here: Walter Noll, Chemistry and Technology of Silicones, Verlag Chemie GmbH, 2nd edition, 1968. The polyether siloxanes according to the invention have different siloxane units which may be combined with one another in the molecule in different ways. The composition of the siloxane units is calculated taking account of the fact that every oxygen atom preferably functions as a bridging member between two silicon atoms in each case, and each silicon atom accordingly only is counted half. The various siloxane units are joined to one another via 2 half oxygen atom (—O_{1/2}O_{1/2}—) groups, as a result an oxygen bridge (—O—) is shown.

It will be apparent to those skilled in the art that the inked siloxane block polymers of general average formula (1) are present in the form of a mixture. It is always a distribution of different structures, so that all indicated indices, e.g. a, b, c, d, e, f and g, represent only mean values. Especially y1, y2 and y3 represent an average value across different structures present in the mixture and as a result the average can be a non-integer number between 0 and 1.

The use of crosslinking molecules providing at least two multiple bonds in the preparation of polyether siloxanes according to formula (1) results in the structural elements that are represented in formula (1) by G. The bridging groups contain (O_{1/2})ₙSiR¹ₘ-groups that are connected by an organic or Si containing radical. In case a difunctional crosslinker is used, then G preferably is represented by independently same or different radicals of type (i), (ii) and (iii)

(O_{1/2})ₙSiR¹ₘ—CH₂CHR¹⁰—R¹¹—CHR¹⁰CH₂—SiR¹ₘ(O_{1/2})ₙ (i)

(O_{1/2})ₙSiR¹ₘ—CH₂CHR¹⁰—R¹¹—CR¹⁰═CH₂ (ii)

(O_{1/2})ₙSiR¹ₘ—CH₂CHR¹⁰—R¹¹—CR¹⁰═CR¹⁰—CH₃ (iii)

with the proviso that the presence of a bridging group with two connected (O_{1/2})ₙSiR¹ₘ-groups, namely radical (i), is mandatory, preferably all radicals (i), (ii), (iii) are mandatory, with
R¹⁰=independently same or different radicals, selected from the group of alkyl radicals having 1-16 carbon atoms or aryl radicals having 6-16 carbon atoms or hydrogen, preferably selected from the group of aryl radicals having 1-6 carbon atoms or aryl radicals having 6-10 carbon atoms or hydrogen, more preferably methyl or hydrogen
R¹¹=independently same or different divalent organic radicals, preferably same or different divalent organic radicals having 1-50 carbon atoms, optionally interrupted by ether, ester or amide groups and optionally bearing OH functions, or (—SiR¹₂O—)ₓSiR¹₂ groups, more preferably same or different divalent organic radicals having 2-30 carbon atoms, optionally interrupted by ether, ester or amide groups and optionally bearing OH functions, or (—SiR¹₂O—)ₓSiR¹₂ groups
x=1 to 50, preferably 1 to 25, more preferably 1 to 10.

Of course, tri- and tetrafunctional crosslinkers may also be used as bridging groups.

The use of at least one compound of formula (1) in the production of flexible hot-cure PU foam enables improved dimension recovery of the shaped hot-cure PU foam article after compression, especially after compression and vacuuming.

Optionally, it is advantageously possible also to additionally use further customary additives, active substances and auxiliaries. Mattresses are very particularly preferred in the context of the present invention. This advantageously also applies to all of the preferred embodiments of our invention.

Advantageously, the shaped hot-cure flexible PU foam article thus provided using the inventive compound(s) of formula (1) therefore has good capability of recovering its original shape even after extended compression over a period of at least 20 hours, especially after compression and vacuuming.

A further advantage is that the shaped hot-cure flexible PU foam articles in question are particularly low in emissions with regard to volatile organic compounds. What is meant more particularly in the context of the present invention by “low in emissions” is that the flexible PU foam that results in accordance with the invention preferably has an emission of ≥0 μg/m³ to ≤500 μg/m³, more preferably ≤200 μg/m³, even more preferably ≤100 μg/m³, appropriately determined by the test chamber method based on DIN standard DIN EN ISO 16000-9:2008-04, 24 hours after test chamber loading. This method is described precisely in EP 3205680A1, specifically in paragraph [0070], which is hereby incorporated by reference.

A further advantage is that the shaped hot-cure flexible PU foam articles in question can also meet emissions specifications such as CertiPur and/or VDA 278. What is meant here by low in emissions according to CertiPur is that total emissions of volatile organic substances (TVOCs) are preferably less than 500 μg/m³, determined according to the method ISO 16000-9 and ISO 16000-11. Further technical details of the requirements for the CertiPUR standard (Version 1. July 2017) can be found at: https//www.europur.org/images/CertiPUR_Technical_Paper-_Full_Version_-_2017.pdf. This latter document (Version 1. July 2017) can also be ordered directly at EUROPUR, Avenue de Cortenbergh 71, B-1000 Brussels, Belgium. “Low-emission” according to VDA 278 is to be understood as meaning that the PU foams meet the specifications of the method Daimler Chrysler PB VWL 709. The VDA 278 method and specification are also described in the examples.

PU foams (polyurethane foams) and the production thereof are well known to those skilled in the art and, per se, require no further elucidation.

The preparation of the polysiloxanes according to formula (1) used in accordance with the invention is known per se. It can be effected, for example, as described in EP0867462B1, especially paragraphs [0029] to [0034], and EP3219738B1, especially paragraphs [0139] to [0144], therein. Reference is hereby made explicitly to EP0867462B1 and EP3219738B1, and especially to its disclosure-content relating to the preparation of the polysiloxanes used in accordance with the invention. The polysiloxanes used in accordance with the invention can generally be prepared by a platinum-catalyzed addition reaction of a siloxane containing a silane hydrogen atom with a linear polyoxyalkylene oxide polyether wherein the linear chain is blocked at one end by an alkyleneoxy group (such as allyloxy or vinyloxy) and bears a hydrogen atom or has been capped, for example, with an alkoxy, aralkyloxy or acyloxy group at the other end. Advantageously, bridging substances are used, which can likewise react in a platinum-catalyzed addition reaction with a siloxane containing a silane hydrogen atom. These are notable in that they have at least two multiple bonds.

In an especially preferred embodiment of the invention hexa-1,5-diene, octa-1,7-diene, trimethylolpropane diallyl ether, trimethylolpropane triallyl ether, pentaerythrityl triallyl ether, divinylbenzene, divinykcyclohexane, butane-1,4-diol divinyl ether, diallyl ethers, diallyl polyethers, dimethallyl polyethers, 1,3-divinyltetramethyldisiloxane, α,ω-divinylsiloxanes, diundecylenic esters, dimethacrylate esters, pentaerythritol tetraacrylate and/or trimethylolpropane triacrylate are used.

The resulting structural elements are represented in formula (1) by G. Especially preferred is the use of trimethylolpropane diallyl ether, butane-1,4-diol divinyl ether, diallyl polyethers, dimethallyl polyethers and/or 1,3-divinyltetramethyldisiloxane as compounds providing at least two multiple bonds. The preparation of the polysiloxanes according to formula (1) is also demonstrated in the experimental part.

In a preferred embodiment of the invention, siloxanes of formula (1) contain an amount of at least 1% by weight of high molecular weight product proportion with a molecular weight of ≥100 000 g/mol, determined by gel permeation chromatography, preferably as described in the experimental part. In a particularly preferred embodiment of the invention, the proportion with a molecular weight≥100 000 g/mol is at least 3% by weight and in a further preferred embodiment at least 5% by weight.

Shaped articles in the context of the invention are shaped bodies of different shape. Preferred shapes in the context of the invention are, for example, geometries such as spheres, cuboids, cylinders etc. Shaped hot-cure PU foam articles in the context of the invention are thus shaped bodies made of polyurethane foam. Particularly preferred shaped flexible hot-cure PU foam articles in the context of the present invention are mattresses and/or cushions and also foam blocks in general.

Mattresses per se and the production thereof are known. They usually consist of a mattress core, e.g. comprising foam, latex, natural products and/or a spring core, and a cover surrounding the mattress. A corresponding situation applies to cushions. In the context of the present application, the term mattress and/or cushion is understood to mean that at least one section made of flexible hot-cure PU foam is present in the mattress and/or the cushion. This preferably means that at least part of the mattress and/or cushion consists of flexible hot-cure PU foam. Based on the total weight of the mattress and/or of the cushion, this part can account for at least 1% by weight or at least 5% by weight or at least 25% by weight, preferably at least 50% by weight, in particular at least 75% by weight. It is also possible for the mattress and/or the cushion to consist entirely of flexible hot-cure PU foam, apart from the cover.

The production of polyurethane foam in general is known per se. It is formed by the tried and tested reaction of at least one polyol component and at least one isocyanate component in the presence of at least one blowing agent (e.g. water) in a polyaddition reaction. It is essential to the present invention that the foam is a flexible PU foam and its manufacturing is carried out in the presence of at least one compound of formula (1).

The polyurethane foam according to the invention is a hot-cure flexible polyurethane foam, or a combination of these flexible PU foams is used, for example two of these flexible PU foams. The term “flexible hot-cure PU foam” is known per se to the person skilled in the art; this is a fixed technical term which is correspondingly established in the specialist field, but will nevertheless be elucidated briefly here.

Flexible PU foams are elastic and deformable and usually have open cells. As a result, the air can escape easily on compression. In addition, there are also rigid PU foams that are inelastic and usually have closed cells, are used for insulation purposes and are not in the focus of the present invention.

There exists a wide variety of flexible PU foams. For instance, the person skilled in the art is aware inter alia of ester foams (made from polyester polyols), flexible hot-cure PU foams and cold-cure PU foams. Viscoelastic flexible PU foams are a relatively new type which may be counted among the hot-cure flexible PU foams.

In a preferred embodiment, the shaped flexible PU foam article is characterized in that the hot-cure flexible PU foam is a standard flexible PU foam, viscoelastic PU foam or a hypersoft PU foam. Preferably, the hot-cure flexible PU foam is a standard flexible PU foam.

The crucial difference between a flexible hot-cure PU foam and a cold-cure PU foam lies in the different mechanical properties. It is possible to differentiate between flexible hot-cure PU foams and flexible cold-cure PU foams via rebound resilience in particular, also called ball rebound (BR) or resilience. A method of determining the rebound resilience is described, for example, in DIN EN ISO 8307:2008-03. Here, a steel ball having a fixed mass is allowed to fall from a particular height onto the test specimen and the height of the rebound in % of the drop height is then measured. The values in question for a cold-cure flexible PU foam are preferably in the region of >50%. Cold-cure flexible PU foams are therefore also often referred to as HR foams (HR: High Resilience). By contrast, hot-cure flexible PU foams have rebound values of preferably 1% to not more than 50%. In the context of a preferred embodiment of the invention, the hot-cure flexible PU foams according to the invention therefore have rebound values of preferably 1% to not more than 50%, determinable in accordance with DIN EN ISO 8307:2008-03. A further mechanical criterion is the sag or comfort factor. In this case, a foam sample is compressed in accordance with DIN EN ISO 2439 and the ratio of compressive stress at 65% and 25% compression is measured. Cold-cure flexible PU foams here have a sag or comfort factor of preferably >2.5. Hot-cure flexible PU foams have a value of preferably <2.5. In a preferred embodiment of the invention, the hot-cure flexible PU foams of the invention therefore have a sag or comfort factor of preferably <2.5, determinable as specified above.

An exact definition of the properties can also be taken, for example, from the data sheet “PUR-Kaltschaum” [Cold-Cure PU Foam] from the Fachverband Schaumkunststoffe und Polyurethane e.V. [Specialist Association Foamed Plastics and Polyurethanes9 , Reference KAL20160323, last update 23.03.2016. (httosJ/www.fsk-vsv.de/wo-content/uploads/2017/03/Produktbeschreibuna-PUR-Kalt-schaum.Ddf). This data sheet can also be ordered directly from the Fachverband Schaumkunststoffe und Polyurethane e.V. (FSK), postal address: Stammheimerstr. 35, D-70435 Stuttgart.

The two names hot-cure flexible PU foam and cold-cure flexible PU foam are explained by the historical development of PU technology, and do not necessarily mean that different temperatures occur in the foaming process.

The different mechanical properties of hot-cure PU foams and cold-cure PU foams result from differences in the formulation for production of the foams. In the case of a cold-cure flexible PU foam, predominantly high-reactivity polyols having primary OH groups and average molar mass>4000 g/mol are usually used. Optionally, low molecular weight crosslinkers are also used, and it is also possible for the function of the crosslinker to be assumed by higher-functionality isocyanates. In the case of hot-cure flexible PU foams, comparatively predominantly unreactive polyols having secondary OH groups and an average molar mass of <4000 g/mol are preferably used. In the case of cold-cure flexible PU foams, reaction of the isocyanate groups with the hydroxyl groups thus occurs as early as in the expansion phase (CO₂ formation from —NCO and H₂O) of the foam. This rapid polyurethane reaction usually leads, as a result of a viscosity increase, to a relatively high intrinsic stability of the foam during the blowing process.

Cold-cure flexible PU foams are usually highly elastic foams. Due to the high intrinsic stability, the cells have generally not been opened sufficiently at the end of the foaming operation and the cell structure additionally has to be open by mechanical crushing. In the case of hot-cure flexible PU foams, by contrast, this is typically not necessary. Highly active stabilizers are defined by formula (1) and (5). In the case of hot-cure flexible PU foams according to the invention, a silicone compound of the formula (1) is used in the production. Additionally, a silicone compound of formula (6) might be used optionally.

Open-cell hot-cure flexible PU foams preferably have a gas permeability (also called “porosity”) within a range from 0.5 to 6.5 scfm. This is measured by applying a pressure differential and measuring the volume of air that flows through in accordance with ASTM D 3574 (2011-00). The method is elucidated in detail in the examples (see porosity determined by the flow method therein). Scfm (standard cubic feet per minute) is measured under standard conditions (23° C., 100 kPa).

Depending on the application, hot-cure flexible PU foams preferably have a foam density between 8 and 80 kg/m³. Especially when such hot-cure flexible PU foams are used as mattresses, mattress constituents and/or cushions, said foams are differentiated according to regional needs, requirements and preferences of consumers. The preferred hot-cure flexible PU foam for mattress applications has a foam density of preferably 20 to 40 kg/m³.

A specific class of hot-cure flexible PU foams is that of viscoelastic PU foams. These are also known as “memory foam” and exhibit both a low rebound resilience (preferably <10%) and a slow, gradual recovery after compression (recovery time preferably 2-10 s). Materials of this kind are well known in the prior art and are highly valued in particular for their energy- and sound-absorbing properties too. Typical viscoelastic flexible foams usually have a lower porosity and a high density (or a high foam density (FD)) compared to other hot-cure flexible PU foams. Cushions have a foam density of preferably 30-50 kg/m³ and are thus at the lower end of the density scale typical of viscoelastic foams, whereas viscoelastic PU foams for mattresses preferably have a density in the range of 50-130 kg/m³.

In hot-cure flexible PU foams, the hard and soft (low glass transition temperature) segments become oriented relative to one another during the reaction and then spontaneously separate from one another to form morphologically different phases within the “bulk polymer”. Such materials are also referred to as “phase-separated” materials. The glass transition temperature in the case of viscoelastic foams is preferably between −20 and +15° C. The glass transition temperature of other hot-cure flexible PU foams and cold-cure flexible PU foams, by contrast, is usually below −35° C. Such “structural viscoelasticity” in the case of open-cell viscoelastic hot-cure flexible PU foams which is based essentially on the glass transition temperature of the polymer should be distinguished from a pneumatic effect. In the latter case, the cell structure is relatively closed (low porosity). As a result of the low air permeability, the air flows back in only gradually after compression, which results in slowed recovery.

Various hot-cure flexible PU foams are classified not only according to foam density but often also according to their compressive strength, also referred to as load-bearing capacity, for particular applications. For instance, compressive strength CLD (compression load deflection), 40% in accordance with DIN EN ISO 3386-1:2015-10, for hot-cure flexible PU foams is preferably in the range of 0.5-8.0 kPa; viscoelastic polyurethane foams preferably have values of 0.1-5.0 kPa, especially 0.5-2.5 kPa. Hypersoft polyurethane foams may be counted among the group of hot-cure flexible PU foam and preferably have values of 0.1-3.0 kPa, especially 0.5-2.0 kPa.

In a preferred embodiment of the invention, the flexible hot-cure PU foams to be used in accordance with the invention have the following preferred properties in respect of rebound resilience, foam density and/or porosity, namely a rebound resilience of 1% to 50%, measured in accordance with DIN EN ISO 8307:2008-03, and/or a foam density of 5 to 150 kg/m³ and/or a porosity of 0.5 to 6 scfm, preferably 1.0 to 6.0 scfm. Particular preference is given to all 3 criteria in respect of rebound resilience, foam density and/or porosity, as indicated above, being satisfied. In particular, the flexible polyurethane foam used according to the invention has a compressive strength CLD, 40% in accordance with DIN EN ISO 3386-1:2015-10, of 0.1 to 8.0 kPa.

Hot-cure flexible polyurethane foam and the production thereof are known per se. For the purposes of the present invention, a preferred hot-cure flexible polyurethane foam has, in particular, a compressive strength CLD, 40% in accordance with DIN EN ISO 3386-1:2015-10, of 0.5-8.0 kPa and/or a rebound resilience of 1-50%, measured in accordance with DIN EN ISO 8307:2008-03, and/or a foam density of 8 to 80 kg/m and/or a porosity of 0.5 to 6 scfm, preferably 1.0 to 6.0 scfm. A possible production method is described, for example, in EP 2481770 or EP2182020. For the purposes of the present invention, a preferred viscoelastic flexible polyurethane foam has, in particular, a glass transition temperature between −20° C. and +15° C. and/or a compressive strength CLD, 40% in accordance with DIN EN ISO 3386-1:2015-10, of 0.1-5.0 kPa, in particular 0.5-3.0 kPa, and/or a rebound resilience of <10%, measured in accordance with DIN EN ISO 8307:2008-03, and/or a foam density of 30 to 130 kg/m and/or a porosity (after crushing the foam) of 0.5 to 6.0 scfm, preferably 1.0 to 6.0 scfm. A possible method of production is described, for example, in EP2822982. The glass transition temperature can be measured by means of dynamic mechanical analysis (DMA) (DIN 53513:1990-03) or by means of differential calorimetry (DSC) (ISO 11357-2:2013). Strictly speaking, it is a glass transition range which extends over a temperature range. The reported glass transition temperatures are average values.

The shaped flexible PU foam article according to the invention, especially the mattress according to the invention, in a preferred embodiment of the invention, has a height of at least 1 cm to not more than 50 cm and a width of from at least 20 cm to not more than 300 cm, and a length of at least 20 cm to not more than 300 cm. Preferred dimensions are, for example, heights in the range from 5 cm to 40 cm, widths in the range from 70 cm to 200 cm, lengths in the range from 150 cm to 220 cm. The shaped PU foam article according to the invention, especially the cushion according to the invention, in a preferred embodiment of the invention, may also have a height of at least 1 cm to not more than 40 cm and a width of at least 15 cm to not more than 200 cm and a length of at least 15 cm to not more than 200 cm, examples of preferred dimensions being heights in the range from 2 cm to 30 cm, widths in the range from 15 cm to 50 cm, lengths in the range from 15 cm to 50 cm.

In a further preferred embodiment of the invention, the shaped flexible PU foam article takes the form of a mattress and preferably the form of a multizone mattress. The different zones differ in terms of, in particular, the respective hardness. Such multizone mattresses and the production thereof are known per se. They are widely sold commercially. In particular, the mattress has up to seven zones of differing hardness which extend over the longitudinal direction of the mattress and are given the appropriate width. When the mattress has various hardness zones distributed over its area, which are formed, in particular, by cuts and/or hollow spaces in the mattress, this constitutes a further preferred embodiment of the invention.

In a further preferred embodiment of the invention, the shaped flexible PU foam article may also be a cold-cure PU foam mattress, a viscoelastic flexible PU foam mattress, a hot-cure flexible PU foam mattress, a PU gel foam mattress, a latex mattress or a box spring mattress, each containing at least a portion made of a flexible hot-cure PU foam according to the invention. These types of mattress are known per se to those skilled in the art and are also marketed worldwide under these names. Mattresses made solely of flexible PU foam are usually referred to on the market simply as foam mattresses. The term mattress as used for the purposes of the present invention also encompasses corresponding mattress coverings and underlays.

In a preferred embodiment of the invention, the shaped flexible PU foam article, preferably the mattress, has the feature that based on its starting volume the shaped flexible PU foam article is compressed by at least 20%, preferably at least 30%, in particular at least 40%, and kept in compressed form by an auxiliary means, in particular packaging means, for at least 20 hours.

Suitable auxiliary means, in particular packaging means, are bags and/or films such as are known from the field of roll-up mattresses for example. The bags and/or films may be sealed by any desired means, such as by a clip, or by an adhesive tape or by welding. The function of the auxiliary means is that of maintaining the compressed shape until the end user of the shaped flexible PU foam article wishes to use said shaped article again in the normal way. After removal of the auxiliary means, in particular the packaging means, the compressed shaped article expands again and in the optimal case recovers its original shape and size. The present invention makes it possible to allow improved dimensional recovery after compression over a period of at least 20 hours.

In a further preferred embodiment, the shaped flexible PU foam article is in a compressed and vacuum-packed state and in particular is a roll-up mattress in a vacuum-packed and compressed state.

The provision of the various flexible PU foams which can be used in the context of the present invention is known per se and it is possible to make use of all proven processes with the proviso that the flexible PU foam is produced in the presence of at least one compound of formula (1).

In a preferred embodiment, the inventive shaped flexible PU foam article is characterized in that the compound of formula (1) is included in a total of 0.05% to 3.0% by weight, preferably from 0.07% to 2.5% by weight, more preferably 0.10% to 2.0% by weight, based on the entire flexible PU foam.

In a further preferred embodiment, the inventive shaped flexible PU foam article has been obtained with additional use of recycled polyols.

The production of corresponding flexible PU foams in principle requires no further explanation, but some preferred details of the production of the PU foam used for the purposes of the invention are given below. The subject matter of the invention will be described by way of example below, without any intention that the invention be restricted to these illustrative embodiments. Where ranges, general formulae or classes of compounds are specified below, these are intended to encompass not only the corresponding ranges or groups of compounds which are explicitly mentioned but also all subranges and subgroups of compounds which can be obtained by removing individual values (ranges) or compounds. Where documents are cited in the context of the present description, the entire content thereof, particularly with regard to the subject matter that forms the context in which the document has been cited, is intended to form part of the disclosure content of the present invention. Unless stated otherwise, percentages are FIGURES in percent by weight. When average values are reported below, the values in question are weight averages, unless stated otherwise. Where parameters which have been determined by measurement are reported below, the measurements have been carried out at a temperature of 23° C. and a pressure of 100 kPa, unless stated otherwise. Unless stated otherwise, compression of the foam in the context of the present invention means that the foam is preferably compressed by at least 20%, based on its starting volume, in particular over a period of at least 20 hours.

For the purposes of the present invention, polyurethanes are all reaction products derived from isocyanates, in particular polyisocyanates, and appropriately isocyanate-reactive molecules. These include polyisocyanurates, polyureas, and allophanate-, biuret-, uretdione-, uretonimine- or carbodiimide-containing isocyanate or polyisocyanate reaction products. It will be apparent that a person skilled in the art seeking to produce the different flexible polyurethane foam types, for example hot-cure flexible PU foams, will appropriately select the substances necessary for each respective purpose, such as isocyanates, polyols, stabilizers, surfactants, etc., in order to obtain the polyurethane type, especially polyurethane foam type, desired in each case. Further details of the usable starting materials, catalysts and auxiliaries and additives can be found, for example, in Kunststoffhandbuch [Plastics Handbook], volume 7, Polyurethane [Polyurethanes], Carl-Hanser-Verlag Munich, 1st edition 1966, 2nd edition 1983 and 3rd edition 1993. The compounds, components and additives which follow are mentioned merely by way of example and can be replaced and/or supplemented by other substances known to those skilled in the art.

The isocyanate components used are preferably one or more organic polyisocyanates having two or more isocyanate functions. Polyol components used are preferably one or more polyols having two or more isocyanate-reactive groups, preferably OH-groups.

Isocyanates suitable as isocyanate components for the purposes of this invention are all isocyanates containing at least two isocyanate groups. Generally, it is possible to use all aliphatic, cycloaliphatic, arylaliphatic and preferably aromatic polyfunctional isocyanates known per se. Preferably, isocyanates are used within a range from 60 to 350 mol %, more preferably within a range from 60 to 140 mol %, relative to the sum total of the isocyanate-consuming components.

Specific examples are alkylene diisocyanates having 4 to 12 carbon atoms in the alkylene radical, e.g. dodecane 1,12-diisocyanate, 2-ethyltetramethylene 1,4-diisocyanate, 2-methylpentamethylene 1,5-diisocyanate, tetramethylene 1,4-diisocyanate and preferably hexamethylene 1,6-diisocyanate (HMDI), cycloaliphatic diisocyanates such as cyclohexane 1,3- and 1,4-diisocyanate and also any mixtures of these isomers, 1-isocyanato-3,3,5-trimethyl-5-isocyanatomethykcyclohexane (isophorone diisocyanate or IPDI for short), hexahydrotolylene 2,4- and 2,6-diisocyanate and also the corresponding isomer mixtures, and preferably aromatic diisocyanates and polyisocyanates, for example tolylene 2,4- and 2,6-diisocyanate (TDI) and the corresponding isomer mixtures, mixtures of diphenylmethane 2,4′- and 2,2′-diisocyanates (MDI) and polyphenylpolymethylene polyisocyanates (crude MDI) and mixtures of crude MDI and tolylene diisocyanates (TDI). The organic diisocyanates and polyisocyanates can be used individually or in the form of mixtures thereof. It is also possible to use isocyanates which have been modified by the incorporation of urethane, uretdione, isocyanurate, allophanate and other groups, called modified isocyanates.

Particularly suitable organic polyisocyanates which are therefore used with particular preference are various isomers of tolylene diisocyanate (tolylene 2,4- and 2,6-diisocyanate (TDI), in pure form or as isomer mixtures of various composition), diphenylmethane 4,4′-diisocyanate (MDI), “crude MDI” or “polymeric MDI” (contains the 4,4′ isomer and also the 2,4′ and 2,2′ isomers of MDI and products having more than two rings) and also the two-ring product which is referred to as “pure MDI” and is composed predominantly of 2,4′ and 4,4′ isomer mixtures, and prepolymers derived therefrom. Examples of particularly suitable isocyanates are detailed, for example, in EP 1712578, EP 1161474, EP 1770117 and EP 1678232, which are hereby fully incorporated by reference.

Polyols suitable as polyol component for the purposes of the present invention are all organic substances having two or more isocyanate-reactive groups, preferably OH groups, and also formulations thereof. Preferred polyols are all polyether polyols and/or hydroxyl-containing aliphatic polycarbonates which are customarily used for producing polyurethane systems, in particular polyurethane foams, in particular polyether polycarbonate polyols and/or filled polyols (polymer polyols) such as SAN, PHD and PIPA polyols which contain solid organic fillers up to a solids content of 45% or more in dispersed form, and/or autocatalytic polyols which contain catalytically active functional groups, in particular amino groups, and/or polyols of natural origin, known as “natural oil-based polyols” (NOPs). The polyols for hot-cure flexible PU foam preferably have a functionality of 1.8 to 8 and number-average molecular weights in the range from 500 to 4000 g/mol. The polyols having OH numbers in the range from 25 to 400 mg KOH/g are preferably used. The number-average molecular weights are preferably determined by gel permeation chromatography (GPC), especially using polypropylene glycol as reference substance and tetrahydrofuran (THF) as eluent. The OH numbers can be determined, in particular, in accordance with the DIN standard DIN 53240:1971-12.

Depending on the required properties of the resulting foams, it is possible to use appropriate polyols, as described for example in: EP1770117, WO2007111828 or US20070238800. Further polyols are known to those skilled in the art and can be found, for example, in EP0380993 or U.S. Pat. No. 3,346,557.

The preferred polyether polyols are obtainable by addition of alkylene oxides to starter molecules, which contain preferably 2 to 8 active hydrogen atoms. Methods that can be found in the state of the art are for example the anionic polymerization of alkylene oxides in the presence of alkali metal hydroxides, alkali metal alkoxides or amines as catalysts, or the cationic polymerization of alkylene oxides in the presence of Lewis acids such as, for example, antimony pentachloride or boron trifluoride etherate, or polymerization using double metal cyanide catalysts. Suitable alkylene oxides preferably contain 2 to 4 carbon atoms in the alkylene radical. Examples are ethylene oxide, 1,2-propylene oxide, 1,2-butylene oxide and 2,3-butylene oxide; ethylene oxide and 1,2-propylene oxide are preferably used. It is also possible to use alkylene oxides which contain more carbon atoms, e.g. styrene oxide. The alkylene oxides can be used individually, cumulatively, in blocks, in alternation or as mixtures. Starter molecules used may especially be compounds having at least 2, preferably 2 to 8, hydroxyl groups, or having at least two primary amino groups in the molecule. Starter molecules used may, for example, be water, di-, tri- or tetrahydric alcohols such as ethylene glycol, propane-1,2-diol and propane-1,3-diol, diethylene glycol, dipropylene glycol, glycerol, trimethylolpropane, pentaerythritol, castor oil, etc., higher polyfunctional polyols, especially sugar compounds, for example glucose, sorbitol, mannitol and sucrose, polyhydric phenols, resols, for example oligomeric condensation products of phenol and formaldehyde and Mannich condensates of phenols, formaldehyde and dialkanolamines, and also melamine, or amines such as aniline, EDA, TDA, MDA and PMDA, more preferably TDA and PMDA. The choice of the suitable starter molecule depends on the particular application of the resulting polyether polyol in the polyurethane foam production. For example, polyols used for production of flexible PU foams are different from those used in the production of rigid PU foams.

In a preferred embodiment of the invention, especially for the production of hot cure flexible slabstock foam, polyether alcohols having secondary hydroxyl groups in amounts of preferably above 50%, more preferably above 90%, are used, especially those having a propylene oxide block or random propylene oxide and ethylene oxide block at the chain end, or those based solely on propylene oxide blocks. Such polyether alcohols preferably have a functionality of 2 to 8, more preferably 2 to 4, number-average molecular weights in the range from 500 to 4000 g/mol, preferably 800 to 4000 g/mol, more preferably 2500 to 4000 g/mol, and typically OH numbers in the range from 20 to 100 mg KOH/g, preferably 40 to 60 mg KOH/g.

In a further preferred embodiment of the invention, di- and/or trifunctional polyether alcohols comprising primary hydroxyl groups in amounts of preferably above 50%, more preferably above 80%, in particular those having an ethylene oxide block at the chain end, are additionally also used. Polyols for cold-cure flexible PU foams (“HR polyols”) form a part of this category if the molar mass is simultaneously >4000 g/mol. According to the required properties of this embodiment which is preferred in accordance with the invention, especially for production of the abovementioned hot-cure flexible PU foams, preference is given to using not only the polyether alcohols described here but also further polyether alcohols which bear primary hydroxyl groups and are based predominantly on ethylene oxide, in particular having a proportion of ethylene oxide blocks of >70%, preferably >90% (“hypersoft polyol”). All polyether alcohols described in the context of this preferred embodiment preferably have a functionality of 2 to 8, more preferably 2 to 5, number-average molecular weights in the range from 500 to 8000 g/mol, preferably 500 to 7000 g/mol, and typically OH numbers in the range from 5 to 100 mg KOH/g, preferably 20 to 60 mg KOH/g. Polyols having primary OH functions are used here in the case of the hot-cure flexible PU foams of the invention, in a preferred embodiment, not alone but rather in combination with polyols having secondary OH groups. Polyols having primary OH functions are used here in the combination, in a preferred embodiment, only to an extent of <50%.

In a further preferred embodiment of the invention, especially for production of viscoelastic flexible PU foams, preference is given to using mixtures of various, preferably two or three, polyfunctional polyether alcohols. The polyol combinations used here preferably consist of a low molecular weight “crosslinker” polyol having high functionality, preferably having an OH number from 100 to 400 mg KOH/g, and/or a conventional high molecular weight flexible slabstock foam polyol or HR polyol and/or a ‘hypersoft’ polyether polyol, preferably having an OH number of 20 to 40 mg KOH/g, with a high proportion of ethylene oxide and having cell-opening properties. If HR polyols are also used in the viscoelastic foam formulation, the proportion by mass thereof in the polyol mixture preferably is <50%.

In a further preferred embodiment of the invention, recycled polyols are used. A shaped flexible PU foam article that has been obtained with additional use of recycled polyols corresponds to a preferred embodiment of the invention. The use of recycled polyols normally leads to problems with the recovery of shape after roll compression. In the context of the present invention, it has been found that, surprisingly, the use of at least one compound of formula (1), as elucidated in detail in this description, enables the alleviation of this problem.

Recycled polyols are polyols that are obtained from PU foam waste. This may be production waste from flexible PU foam production or from flexible PU foam waste after use by the consumer (for example old mattresses). In both cases, PU foam is liquefied by chemical processes. Various processes are useful here, for example, glycolysis, hydrolysis or acidolysis. The liquid recycled polyol obtained can then be reused for production of flexible PU foam. However, such flexible PU foams often feature distinctly adverse mechanical properties, such as resistance to roll compression. One source for further information on the use of recycled polyols in flexible PU foams is the following BMBF research report: httpsJ/www.cleaner-production.de/fileadmin/assets/bilder/BMBF-Projekte/01R105070-075_-Abschlussbericht.pdf.

The additional use of recycled polyols in the context of the invention corresponds to a preferred embodiment of the invention for each item of subject-matter claimed.

Polyester polyols usable with preference are based on esters of polybasic aliphatic or aromatic carboxylic acids, preferably having 2 to 12 carbon atoms. Examples of aliphatic carboxylic acids are succinic acid, glutaric acid, adipic acid, suberic acid, azelaic acid, sebacic acid, decanedicarboxylic acid, maleic acid and fumaric acid. Examples of aromatic carboxylic acids are phthalic acid, isophthalic acid, terephthalic acid and the isomeric naphthalenedicarboxylic acids. The polyester polyols are obtained by condensation of these polybasic carboxylic acids with polyhydric alcohols, preferably of diols or triols having 2 to 12, more preferably having 2 to 6, carbon atoms, preferably trimethylolpropane and glycerol.

Polyether polycarbonate polyols usable with preference are polyols containing carbon dioxide bound in the form of carbonate. Since carbon dioxide forms as a by-product in large volumes in many processes in the chemical industry, the use of carbon dioxide as comonomer in alkylene oxide polymerizations is of particular interest from a commercial point of view. Partial replacement of alkylene oxides in polyols with carbon dioxide has the potential to distinctly lower the costs for the production of polyols. Moreover, the use of CO₂ as comonomer is very advantageous in environmental terms, since this reaction constitutes the conversion of a greenhouse gas to a polymer. The preparation of polyether polycarbonate polyols by addition of alkylene oxides and carbon dioxide onto hydrogen functional starter substances by use of catalysts is well known. Various catalyst systems can be used here: The first generation was that of heterogeneous zinc or aluminium salts, as described, for example, in U.S. Pat. No. 3,900,424 or U.S. Pat. No. 3,953,383. In addition, mono- and binuclear metal complexes have been used successfully for copolymerization of CO₂ and alkylene oxides (EP 2337809, EP 2285490, EP 2741855 or WD 2011163133). The most important class of catalyst systems for the copolymerization of carbon dioxide and alkylene oxides is that of double metal cyanide catalysts, also referred to as DMC catalysts (U.S. Pat. No. 4,500,704, EP 2091990). Suitable alkylene oxides and hydrogen functional starter substances are the same as used for the preparation of carbonate-free polyether polyols, as described above.

Polyols usable with preference that are based on renewable raw materials, natural oil-based polyols (NOPs), are of increasing interest for production of PU foams with regard to the long-term limits in the availability of fossil resources, namely oil, coal and gas, and against the background of rising crude oil prices, and have already been described many times in such applications (U.S. Pat. Nos. 8,293,808, 8,133,930, 9,045,581, EP 1620483, US 20020103091, EP 1888666 and EP 1678232). A number of these polyols are now available on the market from various manufacturers (EP 1537159, EP 1712576, US 20100240860). Depending on the base raw material (e.g. soybean oil, palm oil or castor oil) and the subsequent workup, the polyols have a different impact on properties in the production of polyurethane foam. In general, it is possible to distinguish between two groups: a) polyols based on renewable raw materials which are modified in such way that they can be used to an extent of 100% for production of polyurethanes (EP 1537159, EP 1712576); b) polyols based on renewable raw materials which, because of the processing and properties of the final PU foam, can replace the petrochemical-based polyol only in a certain proportion (US 20100240860).

A further class of polyols usable with preference is that of the so-called filled polyols (polymer polyols). A feature of these is that they contain dispersed solid organic fillers up to a solids content of 45% or more. SAN, PHD and PIPA polyols are found among typical polyol classes. SAN polyols are prepared by grafting with a copolymer based on styrene-acrylonitrile (SAN). PHD (poly-harnstoff dispersion) polyols are highly reactive polyols containing polyurea particles. PIPA (poly-isocyanate poly-addition) polyols are highly reactive polyols containing polyurethane particles, for example formed by in situ reaction of an isocyanate with an alkanolamine in a conventional polyol.

The solid content, which is preferably between 5% and 45%, based on the polyol, is e.g. responsible for improved cell opening, and so the polyol can be foamed in a controlled manner, especially with TDI, without foam shrinkage. The solid content thus acts as an essential processing aid. A further function is to control and increase the hardness of the PU foams, since the usage of filled polyols allows to obtain foams with increased hardness with an effect depending on the solid content in the final formulation. The formulations with solid containing polyols are distinctly less self-stable and therefore tend to require physical stabilization in addition to the chemical stabilization coming from the crosslinking reaction. Solid containing polyols can be used alone in a formulation or in combination with unfilled polyols as described above.

A further class of polyols usable with preference is of those that are obtained as prepolymers via reaction of a molar excess of polyol with isocyanate, resulting in NCO functional prepolymers. Such prepolymers are preferably used as a solution to obtain a viscosity reduction, e.g. in the polyol corresponding to the polyol used in the preparation of the prepolymers.

A further class of polyols usable with preference is that of the so-called autocatalytic polyols, especially autocatalytic polyether polyols. Polyols of this kind are for example based on polyether blocks, preferably on ethylene oxide and/or propylene oxide blocks, and additionally include catalytically active functional groups, for example nitrogen-containing functional groups, especially amino groups, preferably tertiary amine functions, urea groups and/or heterocycles containing nitrogen atoms. By partial replacement the polyols used in the production of the PU foam by autocatalytic polyols, preferably flexible PU foams, it is possible to reduce the required amount of the catalysts which are additionally used and/or to obtain specific desired foam properties. Suitable polyols are described, for example, in EP 1268598, EP 1699842, EP 1319034, EP 1817356, EP 1442070, EP 1268598, U.S. Pat. Nos. 6,924,321, 6,762,274, EP 2104696, EP 1576026 or EP 2797903 and can be purchased, for example, under the Voractiv™ or Lupranol® trade names.

A preferred ratio of isocyanate and polyol, expressed as the index of the formulation, i.e. as stoichiometric ratio of isocyanate groups to isocyanate-reactive groups (e.g. OH groups, NH groups) multiplied by 100, is in the range from 50 to 140, preferably 70 to 135, more preferably 75 to 130. An index of 100 represents a molar reactive group ratio of 1:1.

The hot-cure flexible PU foams according to the invention can also be produced using catalysts. The expression “catalysts”, for the purposes of the present invention, includes all compounds known from the prior art which are able to catalyze isocyanate reactions and/or are used as catalysts, cocatalysts or activators in the production of polyisocyanate reaction products, in particular polyurethane foams.

Catalysts used in the context of this invention may, for example, be any catalysts for the isocyanate-polyol (urethane formation) and/or isocyanate-water (amine and carbon dioxide formation) and/or isocyanate dimerization (uretdione formation), and/or isocyanate trimerization (isocyanurate formation), and/or isocyanate-isocyanate with CO₂ elimination (carbodiimide formation) and/or isocyanate-amine (urea formation) reactions and/or “secondary” crosslinking reactions such as isocyanate-urethane (allophanate formation) and/or isocyanate-urea (biuret formation) and/or isocyanate-carbodiimide (uretonimine formation).

Suitable catalysts for the purposes of the present invention are, for example, substances which catalyze one of the aforementioned reactions, especially the gelling reaction (isocyanate-polyol), the blowing reaction (isocyanate-water) and/or the dimerization or trimerization of the isocyanate. Such catalysts are preferably nitrogen compounds, especially amines and ammonium salts, and/or metal compounds.

Suitable nitrogen compounds as catalysts, also referred to hereinafter as nitrogen-containing catalysts, for the purposes of the present invention are all nitrogen compounds according to the prior art which catalyze one of the abovementioned isocyanate reactions and/or can be used for production of polyurethanes, especially of polyurethane foams.

Examples of suitable nitrogen-containing compounds as catalysts for the purposes of the present invention are preferably amines, especially tertiary amines or compounds containing one or more tertiary amine groups, including the amines triethylamine, triethanolamine, diethanolamine, N,N-dimethylcycohexylamine, N,N-dicycohexylmethylamine, N,N-dimethylaminoethylamine, N,N,N′,N′-tetramethylethylene-1,2-diamine, N,N,N′,N′-tetramethylpropane-1,3-diamine, N,N,N′,N′-tetramethyl-1,4-butanediamine, N,N,N′,N′-tetramethyl-1,6-hexanediamine, N,N,N′,N″,N″-pentamethyldiethyl-enetriamine, N,N,N′-trimethylaminoethylethanolamine, N,N-dimethylaminopropylamine, N,N-diethyl-aminopropylamine, 1-(2-Aminoethyl)pyrrolidine, 1-(3-Aminopropyl)pyrrolidine, 1-[3-(dimethylamino)propyl-(2-hydroxypropyl)amino]propane-2-ol, 2-[[3-(dimethylamino)propyl]methyl-amino]ethanol, 3-(2-dimethylamino)ethoxypropylamine, N,N-bis[3-(dimethylamino)propyl]amine, N,N,N′,N″,N″-pentamethyldipropylenetriamine, 1-[bis[3-(dimethylamino)propyl]amino]-2-propanol, N,N-bis[3-(dimethylamino)propyl]-N′,N′-dimethylpropane-1,3-diamine, triethylenediamine, 1,4-diazabicyclo[2.2.2]octane-2-yl-methanol, N,N′-dimethylpiperazine, 1,2-dimethylimidazole, N-(2-hydroxypropyl)imidazole, 1-isobutyl-2-methylimidazole, N-(3-aminopropyl)imidazole, N-methylimidazole, 1-(3-aminopropyl-2-methyl-1H-imidazole N-ethylmorpholine, N-methylmorpholine, 2,2,4-trimethyl-2-silamorpholine, N-ethyl-2,2-dimethyl-2-silamorpholine, N-(2-aminoethyl)-morpholine, N-(2-hydroxyethyl)morpholine, bis(2-morpholinoethyl) ether, N,N′-dimethylpiperazine, N-(2-hydroxyethyl)piperazine, N-(2-aminoethyl)piperazine, N,N-dimethylbenzylamine, N,N-dimethylaminoethanol, N,N-diethylaminoethanol, 1-(2-hydroxyethyl)pyrrolidine, 3-dimethylamino-1-propanol, 1-(3-hydroxypropyl)pyrrolidine, N,N-dimethylaminoethoxyethanol, N,N-diethyl-aminoethoxyethanol, bis(2-dimethylaminoethyl) ether, N,N,N′-trimethyl-N′-(2-hydroxyethyl)bis(2-aminoethyl) ether, N,N,N′-trimethyl-N′-3-aminopropyl bisaminoethyl ether, tris(dimethylamino-propyl)hexahydro-1,3,5-tiazine, 1,8-diazabicyclo[5.4.0]undec-7-ene, 1,5-diazabicyclo[4.3.0]non-5-ene, 1,5,7-tiazabicyclo[4.4.0]dec-5-ene, N-methyl-1,5,7-triazabicyclo[4.4.0]dec-5-ene, 1,4,6-triaza-bicyclo[3.3.0]oct-4-ene, 1,1,3,3-tetramethylguanidine, 2-tert-butyl-1,1,3,3-tetramethylguanidine, guanidine, 1,1′-[(3-{bis[3-(dimethylamino)propyl]amino}propy)imino]dipropan-2-ol, (3-aminopropy)-bis[3-(dimethylamino)propyl]amine, 3-dimethylaminopropylurea, 1,3-bis[3-(dimethylamino)-propyl]urea, bis-N,N-(dimethylaminoethoxyethyQisophorone dicarbamate, 3-dimethylamino-N,N-dimethylpropionamide, 6-(dimethylamino)hexan-1-ol and 2,4,6-tris(dimethylaminomethyQphenol. Suitable nitrogen-containing catalysts according to the prior art can be purchased, for example, from Evonik under the TEGOAMIN® and DABCO® trade names.

According to the application, it may be preferable that, in the inventive production of polyurethane foams, quaternized and/or protonated nitrogen-containing catalysts, especially quaternized and/or protonated tertiary amines, are used.

For possible quaternization of nitrogen-containing catalysts, it is possible to use any reagents known as quaternizing reagents. Preference is given to using alkylating agents such as dimethyl sulfate, methyl chloride or benzyl chloride, preferably methylating agents such as, in particular, dimethyl sulfate, as quaternizing agents. Quaternization can likewise be carried out using alkylene oxides, such as ethylene oxide, propylene oxide or butylene oxide, preferably with subsequent neutralization using inorganic or organic acids.

Nitrogen-containing catalysts, if quaternized, may be singly or multiply quaternized. Preferably, the nitrogen-containing catalysts are only singly quaternized. In the case of single quaternization, the nitrogen-containing catalysts are preferably quaternized on a tertiary nitrogen atom.

Nitrogen-containing catalysts can be converted to the corresponding protonated compounds by reaction with organic or inorganic acids. These protonated compounds may be preferable, for example, when a slowed polyurethane reaction is to be achieved or when the reaction mixture is to have enhanced flow behaviour in use.

Organic acids used may, for example, be any organic acids mentioned below, for example carboxylic acids having from 1 to 36 carbon atoms (aromatic or aliphatic, linear or branched), such as formic acid, lactic acid, 2-ethylhexanoic acid, salicylic acid and neodecanoic acid, or else polymeric acids such as polyacrylic or polymethacrylic acids. Inorganic acids used may, for example, be phosphorus-based acids, sulfur-based acids or boron-based acids.

However, the use of nitrogen-containing catalysts which have not been quaternized or protonated is particularly preferred in the context of this invention.

Suitable metal compounds as catalysts, also referred to hereinafter as metallic catalysts, for the purposes of the present invention are all metal compounds according to the prior art which catalyze one of the abovementioned isocyanate reactions and/or can be used for production of polyurethanes, especially of polyurethane foams. They may be selected, for example, from the group of metal-organic or organometallic compounds, metal-organic or organometallic salts, organic metal salts, inorganic metal sats, and from the group of charged or uncharged metallic coordination compounds, especially metal chelate complexes.

The expression “metal-organic or organometallic compounds” in the context of this invention especially encompasses the use of metal compounds having a direct carbon-metal bond, also referred to here as metal organyls (e.g. tin organyls) or organometallic compounds (e.g. organotin compounds). The expression “organometallic or metal-organic salts” in the context of this invention especially encompasses the use of metal-organic or organometallic compounds having salt character, i.e. ionic compounds in which either the anion or cation is organometallic in nature (e.g. organotin oxides, organotin chlorides or organotin carboxylates). The expression “organic metal salts” in the context of this invention especially encompasses the use of metal compounds which do not have any direct carbon-metal bond and are simultaneously metal salts, in which either the anion or the cation is an organic compound (e.g. tin(II) carboxylates). The expression “inorganic metal salts” in the context of this invention especially encompasses the use of metal compounds or of metal salts in which neither the anion nor the cation is an organic compound, e.g. metal chlorides (e.g. tin(II) chloride), pure metal oxides (e.g. tin oxides) or mixed metal oxides, i.e. containing a plurality of metals, and/or metal silicates or aluminosilicates. The expression “coordination compound” in the context of this invention especially encompasses the use of metal compounds formed from one or more central particles and one or more ligands, the central particles being charged or uncharged metals (e.g. metal- or tin-amine complexes). For the purposes of the present invention, the expression “metal-chelate complexes” encompasses especially the use of metal-containing coordination compounds which have ligands having at least two coordination or bonding positions to the metal centre (e.g. metal- or tin-polyamine or metal- or tin-polyether complexes).

Suitable metal compounds, especially as defined above, as possible catalysts in the context of the present invention may be selected, for example, from all metal compounds containing lithium, sodium, potassium, magnesium, calcium, scandium, yttrium, titanium, zirconium, vanadium, niobium, chromium, molybdenum, tungsten, manganese, cobalt, nickel, copper, zinc, mercury, aluminium, gallium, indium, germanium, tin, lead, and/or bismuth, especially sodium, potassium, magnesium, calcium, titanium, zirconium, molybdenum, tungsten, zinc, aluminium, tin and/or bismuth, more preferably tin, bismuth, zinc and/or potassium.

Suitable organometallic salts and organic metal salts, especially as defined above, as catalysts in the context of the present invention are, for example, organotin, tin, zinc, bismuth and potassium salts, in particular corresponding metal carboxylates, alkoxides, thiolates and mercaptoacetates, for example dibutyltin diacetate, dimethyltin dilaurate, dibutyltin dilaurate (DBTDL), dioctyltin dilaurate (DOTDL), dimethyltin dineodecanoate, dibutyltin dineodecanoate, dioctyltin dineodecanoate, dibutyltin dioleate, dibutyltin bis(n-lauryl mercaptide), dimethyltin bis(n-lauryl mercaptide), monomethyltin tris(2-ethylhexyl mercaptoacetate), dimethyltin bis(2-ethylhexyl mercaptoacetate), dibutyltin bis(2-ethylhexyl mercaptoacetate), dioctyltin bis(isooctyl mercaptoacetate), tin(II) acetate, tin(II) 2-ethylhexanoate (tin(II) octoate), tin(II) isononanoate (tin(II) 3,5,5-trimethylhexanoate), tin(II) neodecanoate, tin(II) ricinoleate, tin(II) oleate, zinc(II) acetate, zinc(II) 2-ethylhexanoate (zinc(II) octoate), zinc(II) isononanoate (zinc(II) 3,5,5-trimethylhexanoate), zinc(II) neodecanoate, zinc(II) ricinoleate, bismuth acetate, bismuth 2-ethylhexanoate, bismuth octoate, bismuth isononanoate, bismuth neodecanoate, potassium formate, potassium acetate, potassium 2-ethylhexanoate (potassium octoate), potassium isononanoate, potassium neodecanoate and/or potassium ricinoleate.

In the inventive production of polyurethane foams, it may be preferable to rule out the use of organometallic salts, for example of dibutyltin dilaurate.

Suitable possible metallic catalysts are preferably selected such that they do not have any troublesome intrinsic odour and are essentially toxicologically safe, and such that the resulting polyurethane systems, especially polyurethane foams, preferably have a minimum level of catalyst-related emissions.

In the inventive production of polyurethane foams, it may be preferable, according to the type of application, to use incorporable/reactive or high molecular weight catalysts. Preferred catalysts of this kind may be selected, for example, from the group of the metal compounds, preferably from the group of the tin, zinc, bismuth and/or potassium compounds, especially from the group of the metal carboxylates of the aforementioned metals, for example the tin, zinc, bismuth and/or potassium salts of isononanoic acid, neodecanoic acid, ricinoleic acid and/or oleic acid, and/or from the group of the nitrogen compounds, especially from the group of the low-emission amines and/or the low-emission compounds containing one or more tertiary amine groups, for example described by the amines dimethylaminoethanol, N,N-dimethyl-N′,N′-di(2-hydroxypropyl)-1,3-diaminopropane, N,N-dimethyl-aminopropylamine, N,N,N′-trimethyl-N′-(2-hydroxyethyl)bis(2-aminoethyl) ether, N,N,N′-trimethyl-N′-3-aminopropyl bisaminoethyl ether, N,N-bis[3-(dimethylamino)propyl]propane-1,3-diamine, 1,1′-[(3-{bis[3-(dimethylamino)propyl]-amino}propy)imino]dipropan-2-ol, (3-aminopropyl)bis[3-(dimethyl-amino)propyl]amine, bis(N,N-dimethylaminopropylamine, 8-dimethylaminoethyl-1-hexanol, N-(2-hydroxypropyl)imidazole, N-(3-aminopropyl)imidazole, aminopropyl-2-methylimidazole, N,N,N′-trimethylaminoethylethanolamine, 2-(2-(N,N-dimethylaminoethoxy)ethanol, N-(dimethyl-3-amino-propyl)urea derivatives and alkylaminooxamides, such as bis(N—(N′,N′-dimethylamino-propyl))oxamide, bis(N—(N′,N′-dimethylaminoethyQ)oxamide, bis(N—(N′,N′-imidazolidinylpropy)-oxamide, bis(N—(N′,N′-diethylaminoethyl))oxamide, bis(N—(N′,N′-diethylaminopropyl)oxamide, bis(N—(N′,N′-diethylaminoethyl)oxamide, bis(N—(N′,N′-diethylimino-1-methylpropyl)oxamide, bis(N-(3-morpholinopropylyl)oxamide, and the reaction products thereof with alkylene oxides, preferably having a molar mass in the range between 160 and 500 g/mol.

A preferred inventive process is characterized in that the one or more catalysts are selected from the group of nitrogen-containing compounds preferably amines, especially tertiary amines or compounds containing one or more tertiary amine groups, including triethylenediamine, 1,4-diazabicyclo[2.2.2]octane-2-yl-methanol, diethanolamine and compounds of the general formula (5)

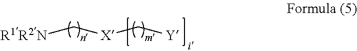

with
X′ represents oxygen, nitrogen, hydroxyl, amines (NR^{3′} or NR^{3′}R⁴) or urea (N(R⁵)C(O)N(R⁶) or N(R⁵)C(O)NR^{6′}R⁷)
Y′ represents amine NR^{8′}R^{9′} or ether OR^{9′}
R^{1′}, R^{2′} represent identical or different aliphatic or aromatic linear or cyclic hydrocarbon radicals having 1-8 carbon atoms optionally bearing an OH-group or representing hydrogen
R^{3′} to R^{9′} represent identical or different aliphatic or aromatic linear or cyclic hydrocarbon radicals having 1-8 carbon atoms optionally bearing an OH or a NH or NH₂ group or representing hydrogen.
m′=0 to 4, preferably 2 or 3
n′=2 to 6, preferable 2 or 3
i′=0 to 3, preferably 0 to 2
preferably with the proviso that at least one of the groups X′, Y′ or R^{1′} to R^{9′} bears a functionality reactive with the polyurethane matrix, preferably an isocyanate-reactive functionality, more preferably NH or NH₂ or OH.

If one or more catalysts are selected from the group of the low-emission amines and/or the low-emission compounds containing one or more tertiary amine groups preferably having a molar mass in the range between 160 and 500 g/mol and/or bearing a functionality reactive with the polyurethane matrix, preferably an isocyanate-reactive functionality, especially preferably NH or NH₂ or OH, then that corresponds to a preferred embodiment of the invention.

If one or more catalysts are selected from the group of the metal-organic or organometallic compounds, metal-organic or organometallic salts, organic metal salts, inorganic metal salts, and from the group of the charged or uncharged metallic coordination compounds, especially the metal chelate complexes, more preferably selected from the group of incorporable/reactive or high molecular weight metal catalysts, further preferred selected from the group tin, zinc, bismuth and/or potassium compounds, especially from the group of the metal carboxylates of the aforementioned metals, for example the tin, zinc, bismuth and/or potassium salts of isononanoic acid, neodecanoic acid, ricinoleic acid and/or oleic acid, then that corresponds to a preferred embodiment of the invention.

Such catalysts and/or mixtures are supplied commercially, for example, under the following names: Jeffcat® ZF-10, Lupragen® DMEA, Lupragen® API, Toyocat® RX 20 and Toyocat® RX 21, DABCO® RP 202, DABCO® RP 204, DABCO® NE 300, DABCO® NE 310, DABCO® NE 400, DABCO® NE 500, DABCO® NE 600, DABCO® NE 650, DABCO® NE 660, DABCO® NE 740, DABCO® NE 750, DABCO® NE 1060, DABCO® NE 1080, DABCO® NE 1082 and DABCO® NE 2039, DABCO® NE 1050, DABCO® NE 1070, DABCO® NE 1065; DABCO® T, POLYCAT® 15; Niax® EF® 860, Niax® EF 890, Niax® EF 700, Niax® EF 705, Niax® EF 708, Niax® EF 600, Niax® EF 602, KOSMOS® 54, KOSMOS® EF, and TEGOAMIN® ZE 1.

According to the application, it may be preferable that, in the inventive production of polyurethane foams, one or more nitrogen-containing and/or metallic catalysts are used. When more than one catalyst is used, the catalysts may be used in any desired mixtures with one another. It is possible here to use the catalysts individually during the foaming operation, for example in the manner of a preliminary dosage in the mixing head, and/or in the form of a premixed catalyst combination.

The expression “premixed catalyst combination”, also referred to hereinafter as catalyst combination, for the purposes of this invention especially encompasses ready-made mixtures of metallic catalysts and/or nitrogenous catalysts and/or corresponding protonated and/or quaternized nitrogenous catalysts, and optionally also further ingredients or additives, for example water, organic solvents, acids for blocking the amines, emulsifiers, surfactants, blowing agents, antioxidants, flame retardants, stabilizers and/or siloxanes, preferably polyether siloxanes, which are already present as such prior to the foaming and therefor are not added as individual components during the foaming operation.

According to the application, it may be preferable when the sum total of all the nitrogen-containing catalysts used relative to the sum total of the metallic catalysts, especially potassium, zinc and/or tin catalysts, results in a molar ratio of 1:0.05 to 0.05:1, preferably 1:0.07 to 0.07:1 and more preferably 1:0.1 to 0.1:1.

In order to prevent any reaction of the components with one another, especially reaction of nitrogen-containing catalysts with metallic catalysts, especially potassium, zinc and/or tin catalysts, it may be preferable to store these components separately from one another and then to feed in the isocyanate and polyol reaction mixture simultaneously or successively.

Suitable use amounts of catalysts are guided by the type of catalyst and are preferably in the range from 0.005 to 10.0 pphp, more preferably in the range from 0.01 to 5.00 pphp (=parts by weight based on 100 parts by weight of polyol) or 0.10 to 10.0 pphp for potassium salts.

Optional additives used may be all substances which are known according to the prior art and find use in the production of polyurethanes, especially of hot-cure flexible PU foams, for example blowing agents, preferably water for formation of CO₂, and, if necessary, further physical blowing agents, crosslinkers and chain extenders, stabilizers against oxidative degradation (called antioxidants), flame retardants, surfactants, biocides, cell-refining or coarsening additives, cell openers, solid fillers, antistatic additives, nucleating agents, thickeners, dyes, pigments, colour pastes, fragrances, emulsifiers, buffer substances and/or catalytically active substances, especially as defined above.

Water is generally used as the blowing agent in the production of hot-cure flexible PU foams. Preference is given to using such an amount of water that the water concentration is from 0.10 to 10.0 pphp (pphp=parts by weight based on 100 parts by weight of polyol).

It is also possible to use suitable physical blowing agents. These are, for example, liquefied CO₂ and volatile liquids, for example hydrocarbons having 3, 4 or 5 carbon atoms, preferably cyclopentane, isopentane and n-pentane, oxygen-containing compounds such as methyl formate, acetone and dimethoxymethane, or chlorinated hydrocarbons, preferably dichloromethane and 1,2-dichloroethane.

Apart from water and the physical blowing agents, it is also possible to use other chemical blowing agents which react with isocyanates to evolve a gas, for example formic acid.

For stabilization of the rising foam mixture and for influencing of the foam properties of polyurethane foams, organomodified siloxanes are preferably used in the production of the different types of PU foams. (Organomodified) siloxanes suitable for this purpose are described for example in the following documents: EP 0839852, EP 0780414, EP 0867465, EP 1544235, EP 1553127, EP 0533202, U.S. Pat. No. 3,933,695, EP 1753799, US 20070072951, DE 2533074. These compounds may be prepared as described in the prior art. Suitable examples are described, for instance, in U.S. Pat. No. 4,147,847, EP 0493836, EP 1520870, EP 0600261, EP 0585771, EP 0415208 and U.S. Pat. No. 3,532,732.

Foam stabilizers for the production of hot-cure flexible PU foams are preferably characterized by large siloxane structures preferably having more than 50 Si units and pendant polyethers. These foam stabilizers are also referred to as polydialkylsiloxane-polyoxyalkylene copolymers. The structure of these compounds is preferably such that, for example, a long-chain copolymer of ethylene oxide and propylene oxide is bonded to a polydimethylsiloxane radical. The linkage between the polydialkylsiloxane and the polyether moiety may be via SiC or Si—O—C linkage. In a preferred embodiment, the polyether moieties are built up from the monomers propylene oxide, ethylene oxide, butylene oxide and/or styrene oxide in blocks or in random distribution, and may either be hydroxy-functional or end-capped by a methyl ether function or an acetoxy function. The molecular masses of the polyether moieties are preferably in a range of 150 to 8000 g/mol. In structural terms, the polyether or the different polyethers may be bonded to the polydialkylsiloxane in terminal or lateral positions. The alkyl radical of the siloxane may be aliphatic, cycloaliphatic or aromatic. Methyl groups are very particularly advantageous. The organomodified polydialkylsiloxane may be linear or else contain branches. Suitable stabilizers, especially foam stabilizers, are described inter alia in U.S. Pat. Nos. 2,834,748, 2,917,480 and in U.S. Pat. No. 3,629,308. The function of the foam stabilizer is to assure the stability of the foaming reaction mixture. The contribution to foam stabilization correlates here with siloxane chain length. Without foam stabilizer, a collapse is observed, and hence no homogeneous foam is obtained. In the case of some flexible PU foam types not according to the invention, that have higher stability and hence a lower tendency to collapse, it is also possible to use low molecular weight polyethersiloxanes. These then have siloxane chain lengths much shorter than 50. For instance, in the case of cold-cure flexible PU foams or ester foams, unmodified or modified short-chain siloxanes are used. When long-chain and hence more potent siloxane stabilizers are used, by contrast, over-stabilization and hence shrinkage after foam production is observed in such foam types.

The inventive compound of formula (1), which was described above, is a foam stabilizer. In a preferred embodiment, further foam stabilizers according to formula (6), which are different from the compound of formula (1), may be used additionally. In another preferred embodiment, no further foam stabilizers, which are different from the compound of formula (1), are used. Optional foam stabilizers according to formula (6) are in accordance with the following structure:

[R^{1″}₂R^{2″}SiO_{1/2}]_{a″}[R^{1″}₃SiO_{1/2}]_{b″}[R^{1″}₂SiO_{2/2}]_{c″}[R^{1″}R^{2″}—SiO_{2/2}]_{d″}[R^{3″}SiO_{3/2}]_{e″}[SiO_{4/2}]_{f″} Formula (6)
with
a″=0 to 12, preferably 0 to 10, more preferably 0 to 8
b″=0 to 8, preferably 0 to 6, more preferably 0 to 2
c″=15 to 300, preferably 40 to 200, more preferably 45 to 120
d″=0 to 40, preferably 0 to 30, more preferably 2 to 20
e″=0 to 10, preferably 0 to 8, more preferably 0 to 6
f″=0 to 5, preferably 0 to 3, more preferably 0
where:
a″+b″+c″+d″+e″+f″>23, preferably >40, more preferably >50
a″+b″≥2
a″+d″≥21
R^{1″}=same or different radicals, selected from the group of alkyl radicals having 1-16 carbon atoms or aryl radicals having 6-16 carbon atoms or hydrogen or —OR^{5″}, saturated or unsaturated, preferably methyl, ethyl, octyl, dodecyl, phenyl or hydrogen, more preferably methyl or phenyl
R^{2″}=independently identical or different polyethers obtainable from the polymerization of ethylene oxide, propylene oxide and/or other alkylene oxides such as butylene oxide or styrene oxide of the general formula (7) or an organic radical according to formula (8)

—(R^{4″})_{g″}—O—[C₂H₄O]_{h″}—[C₃H₆O]_{i″}—[CR^{6″}₂CR^{6″}₂O]_{j″}—R^{7″} Formula (7)

—O_{g″}—R^{8″} Formula (8)
where
g″=0 or 1
h″=0 to 150, preferably 1 to 100, more preferably 1 to 80
i″=0 to 150, preferably 0 to 100, more preferably 0 to 80
j″=0 to 80, preferably 0 to 40, more preferably 0
k″=1-18, preferably 1-10, more preferably 3 or 4
where
h″+i″+j″≥3
R^{3″}=same or different radicals, selected from the group of alkyl or aryl radicals, saturated or unsaturated, unsubstituted or substituted with hetero atoms, preferably alkyl radicals having 1-16 carbon atoms or aryl radicals having 6-16 atoms, saturated or unsaturated, unsubstituted or substituted with halogen atoms, more preferably methyl, vinyl, chlorpropyl or phenyl
R^{4″}=divalent organic radical, preferably a divalent organic alkyl or aryl radical, optionally substituted with —OR^{5″}, more preferably a divalent organic radical of type C_{k″}H_{2k″}
R^{5″}=same or different radicals, selected from the group of alkyl radicals having 1-16 carbon atoms or aryl radicals having 6-16 carbon atoms, saturated or unsaturated, or hydrogen, preferably alkyl radicals having 1-8 carbon atoms, saturated or unsaturated, or hydrogen, more preferably methyl, ethyl, isopropyl or hydrogen
R^{6″}=same or different radicals, selected from the group of alkyl radicals having 1-18 carbon atoms, and optionally bearing ether functions or substitution with halogen atoms, or aryl radicals having 6-18 carbon atoms and optionally bearing ether functions, or hydrogen, preferably alkyl radicals having 1-12 carbon atoms, and optionally bearing ether functions or substitution with halogen atoms, or aryl radicals having 6-12 carbon atoms and optionally bearing ether functions, or hydrogen, more preferably hydrogen, methyl, ethyl or benzyl
R^{7″}=same or different radicals, selected from the group of hydrogen, alkyl, —C(O)—R^{9″}, —C(O)O—R^{9″} or —C(O)NHR^{9″}, saturated or unsaturated, optionally substituted with hetero atoms, preferably hydrogen, alkyl having 1-8 carbon atoms or acetyl, more preferably hydrogen, methyl, acetyl or butyl
R^{8″}=same or different radicals, selected from the group or alkyl radicals or aryl radicals, saturated or unsaturated, and optionally bearing one or more OH, ether, epoxide, ester, amine or/and halogen substituents, preferably alkyl radicals having 1-18 carbon atoms or aryl radicals having 6-18 carbon atoms, saturated or unsaturated, and optionally bearing one or more OH, ether, epoxide, ester, amine or/and halogen substituents, more preferably alkyl radicals having 1-18 carbon atoms or aryl radicals having 6-18 carbon atoms, or aryl radicals having 6-12 carbon atoms, saturated or unsaturated, bearing at least one substituent selected of the group of OH, ether, epoxide, ester, amine or/and halogen substituents
R^{9″}=same or different radicals, selected from the group of alkyl radicals having 1-16 carbon atoms or aryl radicals having 6-16 carbon atoms, saturated or unsaturated, preferably alkyl radicals having 1-8 carbon atoms, saturated or unsaturated, more preferably methyl, ethyl, butyl or phenyl.

In a preferred embodiment of the invention, siloxanes of formula (1) and further foam stabilizers according to formula (6) can contain a low amount of cyclic siloxanes, which means that the total content of the sum of cyclotetrasiloxane (D₄), cyclopentasiloxane (D₅) and cyclohexasiloxane (D₆) is not higher than 0.1% by weight. In a particularly preferred embodiment of the invention, the total content of D₄, D₅ and D₆ is not higher than 0.07% by weight. It is also possible to use the siloxanes of formula (1) and formula (6) as blends with e.g. suitable solvents and/or further additives.

As optional solvents, it is possible to employ all suitable substances known from the prior art. Depending on the application, it is possible to use aprotic nonpolar, aprotic polar and protic solvents. Suitable aprotic nonpolar solvents can, for example, be selected from the following classes of substances, or classes of substances containing the following functional groups: aromatic hydrocarbons, aliphatic hydrocarbons (alkanes (paraffins) and olefins), carboxylic esters (e.g. isopropyl myristate, propylene glycol dioleate, decyl cocoate or other esters of fatty acids) and polyesters, (poly)ethers and/or halogenated hydrocarbons having a low polarity. Suitable aprotic polar solvents can, for example, be selected from the following classes of substances, or classes of substances containing the following functional groups: ketones, lactones, lactams, nitriles, carboxamides, sulfoxides and/or sulfones. Suitable protic solvents can, for example, be selected from the following classes of substances, or classes of substances containing the following functional groups: alcohols, polyols, (poly)alkylene glycols, amines, carboxylic acids, in particular fatty acids and/or primary and secondary amides. Particular preference is given to solvents which are readily employable in the foaming operation and do not adversely affect the properties of the foam. For example, isocyanate-reactive compounds are suitable, since they are incorporated into the polymer matrix by reaction and do not generate any emissions in the foam. Examples are OH-functional compounds such as (poly)alkylene glycols, preferably monoethylene glycol (MEG or EG), diethylene glycol (DEG), triethylene glycol (TEG), 1,2-propylene glycol (PG), dipropylene glycol (DPG), trimethylene glycol (propane-1,3-diol, PDO), tetramethylene glycol (butanediol, BDO), butyl diglycol (BDG), neopentyl glycol, 2-methylpropane-1,3-diol (ORTEGOL® CXT) and higher homologues thereof, for example polyethylene glycol (PEG) having average molecular masses between 200 g/mol and 3000 g/mol. Particularly preferred OH-functional compounds further include polyethers having average molecular masses of 200 g/mol to 4500 g/mol, especially 400 g/mol to 2000 g/mol, among these preferably water-, allyl-, butyl- or nonyl-initiated polyethers, in particular those which are based on propylene oxide (PO) and/or ethylene oxide (EO).

Optional crosslinkers and optional chain extenders are low molecular weight, polyfunctional compounds which are reactive toward isocyanates. Suitable compounds are, for example, hydroxyl- or amine-terminated substances such as glycerol, neopentyl glycol, 2-methyl-1,3-propanediol, triethanolamine (TEOA), diethanolamine (DEOA) and trimethylolpropane. The use concentration can preferably be in the range from 0.1 to 5 parts, based on 100 parts of polyol, but can also deviate therefrom depending on the formulation.

Suitable optional stabilizers against oxidative degradation, known as antioxidants, preferably include all common free-radical scavengers, peroxide scavengers, UV absorbers, light stabilizers, complexing agents for metal ion impurities (metal deactivators). Preference is given to using compounds of the following classes of substances, or classes of substances containing the following functional groups, with substituents on the respective parent molecules preferably being, in particular, substituents which have groups which are reactive toward isocyanate: 2-(2′-hydroxyphenyl)benzotriazoles, 2-hydroxybenzophenones, benzoic acids and benzoates, phenols, in particular comprising tert-butyl and/or methyl substituents on the aromatic entity, benzofuranones, diarylamines, triazines, 2,2,6,6-tetramethylpiperidines, hydroxylamines, alkyl and aryl phosphites, sulfides, zinc carboxylates, diketones. Phenols may, for example, be esters based on 3-(4-hydroxyphenyl)propionic acid such as triethylene glycol bis(3-tert-butyl-4-hydroxy-5-methylphenyl)propionate, octadecyl 3-(3,5-di-tert-butyl-4-hydroxyphenyl)propionate, or methylenediphenols such as 4,4′-butylidenebis(6-tert-butyl-3-methylphenol). Preferred 2-(2′-hydroxyphenyl)benzotriazoles are, for example, 2-(2′-hydroxy-5′-methylphenyl)benzotriazole or 2-(2′-hydroxy-3′,5′-di-tert-butylphenyl)benzotriazole. Preferred 2-hydroxybenzophenones are, for example, 2-hydroxy-4-n-octoxybenzophenone, 2,2′,4,4′-tetrahydroxybenzophenone or 2,4-dihydroxybenzophenone. Preferred benzoates are, for example, hexadecyl 3,5-di-tert-butyl-4-hydroxybenzoate or tannins.

Suitable optional flame retardants in the context of this invention are all substances which are regarded as suitable for this purpose according to the prior art. Preferred flame retardants are, for example, liquid organophosphorus compounds such as halogen-free organophosphates, e.g. triethyl phosphate (TEP), halogenated phosphates, for example tris(1-chloro-2-propyl) phosphate (TCPP) and tris(2-chloroethy) phosphate (TCEP), and organic phosphonates, for example dimethyl methanephosphonate (DMMP), dimethyl propanephosphonate (DMPP), or solids such as ammonium polyphosphate (APP) and red phosphorus. Suitable flame retardants further include halogenated compounds, for example halogenated polyols, and also solids such as expandable graphite and melamine.

Optional Biocides used may, for example, be commercial products such as chlorophene, benzisothiazolinone, hexahydro-1,3,5-tris(hydroxyethyl-s-triazine), chloromethylisothiazolinone, methylisothiazolinone or 1,6-dihydroxy-2,5-dioxohexane, which are known under the trade names BIT 10, Nipacide BCP, Acticide MBS, Nipacide BK, Nipacide CI, Nipacide FC.

The hot-cure flexible PU foams according to the invention can be produced by any methods familiar to the person skilled in the art, for example by manual mixing or preferably with the aid of foaming machines, especially low-pressure or high-pressure foaming machines. Batch processes or continuous processes may be used here.

It is possible to use any methods known to the person skilled in the art for production of hot-cure flexible PU foams. For example, the foaming operation can be affected either in the horizontal or in the vertical direction, in batchwise plants or continuous plants. The compositions used in accordance with the invention may similarity be used for CO₂ technology. Use in low-pressure and high-pressure machines is possible, with the compositions to be processed being able to be metered directly into the mixing chamber or be admixed even before the mixing chamber with one of the components which then go into the mixing chamber. Admixture in the raw material tank is also possible.

A particularly preferred hot-cure flexible PU foam for the purpose of the present invention especially has the following composition:

| Component | Proportion by weight |
|---|---|
| Polyol | 100 |
| Water | 0 to <10, preferably from 0.5 to 6 |
| (Amine) catalyst | 0.05 to 5 |
| Tin catalyst | 0 to 5, preferably from 0.01 to 2 |
| at least one compound | 0.07 to 6.0, preferably 0.10 to 5.0 |
| of formula (1) | |
| Physical blowing agent | 0 to 130 |
| Flame retardant | 0 to 70 |
| Fillers | 0 to 150 |
| Further foam stabilizer * | 0 to 6.0, preferably 0 to 5.0 |
| Further additives | 0 to 20 |
| Isocyanate index: | 75 to 130 |

* foam stabilizers ≠ formula (1)

Another subject of the invention is a process for storing and/or for transporting shaped hot-cure flexible PU foam articles, preferably mattresses and/or cushions, where
(a) in a first step a shaped hot-cure flexible PU foam article is provided by reaction of at least one polyol component and at least one isocyanate component in the presence of at least one blowing agent and of at least one catalyst and further additives, wherein the additives comprise at least one foam stabilizer, which is a compound of formula (1), as defined in claim 1,
(b) in optional subsequent steps the shaped hot-cure flexible PU foam article obtained may optionally be subjected to further processing to prepare it for the application,
(c) and wherein in a final step the shaped hot-cure flexible PU foam article (optionally prepared for the application) is compressed by at least 20%, preferably 30%, especially 40%, based on its starting volume, and optionally vacuum-packed and kept in compressed form by auxiliary means, in particular packaging means, and sent for storage and/or transport.

In a preferred embodiment, this process is characterized in that a sufficient amount of the inventive compound of formula (1), as defined in claim 1, is added in step (a) so that the proportion by mass thereof in the finished polyurethane foam is from 0.05% to 3.0% by weight, preferably from 0.07% to 2.5% by weight, more preferably 0.10% to 2.0% by weight.

Another subject of the invention is a process for producing flexible hot-cure polyurethane foam by reaction of at least one polyol component and at least one isocyanate component in the presence of at least one blowing agent and of at least one catalyst and further additives, wherein the additives comprise at least one foam stabilizer, which is a compound of formula (1), as defined in claim 1, preferably with additional use of recycled polyols.

In a preferred embodiment of the invention, it is a feature of the process that the flexible hot-cure PU foam is a standard flexible PU foam, viscoelastic PU foam or a hypersoft PU foam.

In a preferred embodiment of the invention, the reaction to produce the inventive flexible hot-cure PU foams is effected using
water, and/or
one or more organic solvents, and/or
one or more stabilizers against oxidative degradation, especially antioxidants, and/or
one or more flame retardants, and/or
one or more foam stabilizers, based on polydialkylsiloxane-polyoxyalkylene copolymers, and/or
one or more further auxiliaries, preferably selected from the group of the surfactants, biocides, dyes, pigments, fillers, antistatic additives, crosslinkers, chain extenders, cell openers and/or fragrances.

The invention further provides a flexible hot-cure polyurethane foam, preferably a standard flexible PU foam, viscoelastic PU foam or hypersoft PU foam, which is obtainable by a process as described above.

An inventive flexible hot-cure PU foam wherein the foam has a rebound resilience of 1-50%, measured in accordance with DIN EN ISO 8307:2008-03, and/or a foam density of 5 to 150 kg/m3 and/or a porosity, optionally after crushing the foams, of 0.5 to 6 scfm, preferably 1.0 to 6.0 scfm, corresponds to a preferred embodiment of the invention.

The invention further provides the use of the inventive hot-cure flexible PU foams as packaging foam, mattress, furniture cushion, automobile seat cushion, headrest, dashboard, automobile interior trim, automobile roof liner, sound absorption material, or for production of corresponding products.

The invention further provides the use of at least one compound of formula (1), as defined in claim 1, for improving the dimensional recovery of shaped hot-cure flexible PU foam articles after compression thereof over a period of at least 20 hours, wherein the shaped hot-cure flexible PU foam article is obtainable by reaction of at least one polyol component and at least one isocyanate component in the presence of at least one blowing agent and of at least one catalyst and further additives.

The invention further provides the use of flexible polyurethane foam in mattresses and/or cushions, especially mattresses, wherein the flexible hot-cure PU foam has been obtained by reaction of at least one polyol component and at least one isocyanate component in the presence of one or more catalysts that catalyze the isocyanate-polyol and/or isocyanate-water reactions and/or isocyanate trimerization and further additives, characterized in that the additives comprise at least one foam stabilizer, which is a compound of formula (1), as defined in claim 1, preferably with additional use of recycled polyols.

### EXAMPLES

### GPC Measurements of Foam Stabilizers

The polydispersity and the molar mass averages Mₙ and M_{w} of the non-inventive and inventive foam stabilizers were determined by gel permeation chromatography (GPC) based on ISO 13885-1:2020 under the following conditions: separation column combination SDV 1000/10000 Å with precolumn (length: 65 cm, column temperature: 30° C.), THF as mobile phase, flow rate: 1 ml/min, sample concentration: 10 g/L, injection volume 20 μl, refractive index (RI) detector (30° C.), calibration with polystyrene (162-2520000 g/mol). The obtained values are polystyrene molar mass equivalents.

### Physical Properties of the Flexible PU Foams:

The flexible PU foams produced were assessed according to the following physical properties a) to g):
a) Rise time: The period of time between the end of mixing of the reaction components and the blow-off of the polyurethane foam.
b) Rise height or foam height: the height of the free-risen foam formed after 3 minutes. Foam height is reported in centimetres (cm).
c) Settling of the foam at the end of the rise phase: The settling is calculated from the difference of the foam height after direct blow-off and 3 minutes after foam blow-off. The foam height is measured at the maximum in the middle of the foam crest by means of a needle secured to a centimetre scale. A negative value here describes settling of the foam after blow-off; a positive value correspondingly describes further rise of the foam.
d) Number of cells per cm (cell count): This is determined visually on a cut surface (measured according to DIN EN 15702).
e) Foam density (FD): Determined as described in ASTM D 3574-11 under Test A by measuring the core density. Foam density is reported in kg/m.
f) Porosity determined by the airflow method: In the airflow method in accordance with ASTM D 3574 (2011-00), the volume of air that flows through a defined foam specimen in a particular period of time on application of a pressure differential is determined. For this purpose, 12 test specimens having dimensions of 5 cm×5 cm×2.5 cm were cut out of each of the finished foams transverse to the direction of rise of the foam, and successively inserted into an analytical instrument constructed for this method. The construction of this instrument is described in ASTM D 3574 (2011-00). The analytical instrument generates an air pressure differential of 125 Pa between the inside of the instrument and the surrounding atmosphere by sucking just enough air in through the test specimen for the differential to be kept constant. The air flow through the test specimen is thus a measure of the porosity of the foam. Values in the range from 0-6.5 scfm (standard cubic feet per min) were measured, with lower values within the interval characterizing a more tight foam and higher values a more open foam.
g) Result of the rolling test: This specific test is described in detail below.

For the sake of completeness, the measurement principle of DIN EN ISO 16000-9:2008-04 is also elucidated hereinafter.

The materials are characterized here regarding the type and the amount of the organic substances outgassable therefrom. The analysis method serves to ascertain emissions from materials that are used in furniture and mattresses. This is done by using test chambers to measure the emissions.

### Analysis:

### Test Specimen: Sample Preparation, Sampling and Specimen Dimensions

The reaction mixture is introduced into a PE plastic bag which is open at the top. After the foam has risen and blown off, the PE bag is closed 3 min after the blow-off. The foam is stored in this way at room temperature for 12 hours in order to enable complete reaction, but simultaneously in order to prevent premature escape of VOCs. Subsequently, the PE bag is opened and a 7 cm×7 cm×7 cm cube is taken from the centre of the foam block and immediately wrapped in aluminium foil and sealed airtight in a PE bag. It was then transported to the analytical laboratory, and the foam cube was introduced into a cleaned 30 l glass test chamber. The conditions in the test chamber were controlled climatic conditions (temperature 21° C., air humidity 50%). Half the volume of the test chamber is exchanged per hour. After 24 hours, samples are taken from the test chamber air. Tenax adsorption tubes serve to absorb the VOCs. The Tenax tube is then heated, and the volatile substances released are cryofocused in a cold trap of a temperature-programmable evaporator with the aid of an inert gas stream. After the heating phase has ended, the cold trap is rapidly heated to 280° C. The focused substances vaporize in the process. They are subsequently separated in the gas chromatography separation column and detected by mass spectrometry. Calibration with reference substances permits a semi-quantitative estimate of the emission, expressed in “μg/m³”. The quantitative reference substance used for the VOC analysis (VOC value) is toluene. Signal peaks can be assigned to substances using their mass spectra and retention indices. The following equipment is used for the analysis: Gerstel, D-45473 Mühlheim an der Ruhr, Eberhard-Gerstel-Platz 1, Germany, TDS-3/KAS-4, Tenax® desorption tubes, Agilent Technologies 7890A (GC)/5975C (MS), column: HP Ultra2 (50 m, 0.32 mm, 0.52 μm), carrier gas: helium. More specific procedural instructions can be taken from DIN EN ISO 16000-9:2008-04.

The analytical principles of VDA 278 are also described hereinbelow for the sake of completeness.

### VDA 278 Analytical Principles:

The materials are characterized regarding the type and the amount of the organic substances outgassable therefrom. To this end, two semi-quantitative empirical values are determined to estimate the emission of volatile organic compounds (VOC value) and also the proportion of condensable substances (fogging value). Individual substances of the emission are also determined. In the analysis, the samples are thermally extracted and the emissions are separated by gas chromatography and detected by mass spectrometry. The overall concentrations thus obtained for the VOC fraction are arithmetically converted into toluene equivalents and provide the VOC value as a result; the FOG fraction is represented in hexadecane equivalents and provides the FOG value.

The analytical method serves to determine emissions from non-metallic materials used for moulded parts in motor vehicles; they also include foams.

In thermal desorption analysis (TDS), small amounts of material are heated up in a desorption tube in a defined manner and the volatile substances which are emitted in the course of heating are cryofocused by means of an inert gas stream in a cold trap of a temperature-programmable vaporizer. After the heating phase has ended, the cold trap is rapidly heated to 280° C. The focused substances vaporize in the process. They are subsequently separated in the gas-chromatographic separation column and detected by mass spectrometry. Calibration with reference substances permits a semi-quantitative estimate of the emission, expressed in “μg/g”. The quantitative reference substances used are toluene for the VOC analysis (VOC value) and n-hexadecane for the fogging value. Signal peaks can be assigned to substances using their mass spectra and retention indices. Source: VDA 278/10.2011, www.vda.de

Described below is the rolling deformation test which makes it possible to test dimensional recovery after compression in the context of the present invention.

### Rolling Deformation Test (“Rolling Test” for Short)

### Objective:

The test has for its object to simulate the conditions of rolled mattresses in the laboratory. Since there is no meaningful industry standard for this a novel test was developed which simulates the rolling-up of mattress foams on a small scale.

### Sample Preparation:

Test specimens having dimensions of 12 cm (width), 16 cm (length) and 2.5 cm (thickness) are cut out of the flexible PU foam blocks as obtained from manual foaming for example, using a band saw. A central position in the foam blocks from manual foaming is selected. The test specimen is cut out such that the rise direction of the foam during production is at right angles to the length and width of the test specimen. Test specimens are marked with a felt pen.

### Test Procedure:

The test specimen is compressed with a thin metal rod of diameter 5-8 mm (e.g. metal ballpoint pen) at a 12 cm edge. The foam test specimen is then rolled up around this metal rod by hand. This significantly compresses the foam, forming a roll having a diameter of about 3-4 cm. This roll is held manually in this compressed state and pushed completely into a cardboard tube. The cardboard tube has an internal diameter of 4 cm and a length of at least 13 cm. As soon as the rolled-up foam is fully inserted in the tube the metal rod is removed. To minimize friction during removal the metal rod may be lightly greased before the rolling of the foam. The foam then fills the volume of the tube. The compression of the foam in the centre is much more severe than at the edge of the tube. The roll is then stored under controlled, constant conditions (temperature: 21° C., atmospheric humidity: 60%) for 7 days. After 168 hours the foam is manually removed from the tube and placed on an even surface, and the unrolling of the foam is observed. The expansion of the foam must not be disturbed or influenced.

### Evaluation:

The shaped flexible PU foam article is left to expand for 10 minutes. The test specimens are then evaluated. The most important criterion is whether the foam has completely recovered its original thickness or—especially at the more severely compressed edge—still has compression zones. In some cases, a groove from the compression is also apparent on the surface of the test specimen. Very poor test specimens remain rolled up at one end. A slight bend in the test specimen after expansion is normal and is not considered in the assessment. The following grades were used for the evaluation:
+++: Test specimen has fully unrolled, no compression lines or compressions apparent whatsoever, expansion occurs rapidly and is already complete after 5 min.
++: The test specimen has regained a thickness of 2.5 cm at all sites. No indentations and grooves remain visible at the surface after 10 minutes (particularly at the more severely compressed end).
+: The test specimen has regained a thickness of 2.5 cm at all sites. However, slight indentations and grooves remain visible at the surface (particularly at the more severely compressed end).
0: The test specimen exhibits a slight compression at the more severely compressed end. The thickness there is more than 2.0 cm but less than 2.5 cm. An indentation is clearly visible at this end.
−: Test specimen exhibits a slight compression at the more severely compressed end. The thickness of the sample there is more than 1 cm but still considerably less than 2.0 cm.
−−: Test specimen exhibits a severe compression at the more severely compressed end. The thickness of the sample there is less than 1 cm. The sample is still partly rolled up at this end.
−−−: Test specimen remains rolled up and compressed at the more severely compressed end.

The evaluation is preferably performed by at least two people. The results are documented. In the context of the present invention the evaluation was carried out by four people who arrived at consistent results.

### Deficiencies and Constraints of the Test:

Correct dimensions of the test specimen and uniform rolling must be ensured in the test. The foam test specimen must have constant cell structure parameters, i.e. in particular a constant cell size and a constant air permeability. The metal rod must not be excessively greased so that no grease penetrates into the sample. Constant storage conditions must be maintained. Test specimens given the various evaluation grades must be kept available for comparison.

### Precision of the Test:

Performance of the test with two or more people for evaluation regularly results in consistent assessments. Additionally, in duplicate measurements the same result was regularly confirmed. The test has thus proven reliability.

### Hot-Cure Flexible PU Foam—Foaming Examples:

### Example 1: Production of Hot-Cure Flexible PU Foams (Flexible Slabstock Foam)

For the performance testing of the inventive compounds of the formula (1), the hot-cure flexible PU foam formulation specified in Table 1 was used.

TABLE 1
Formulation 1 for hot-cure flexible PU foam production.

| Formulation 1 | Parts by mass (pphp) |
|---|---|
| Polyol 1¹⁾ | 100 |
| water | 4.00 |
| Tin catalyst²⁾ | 0.20-0.28 |
| TEGOAMIN ® DMEA³⁾ | 0.15 |
| FOAM STABILIZER⁴⁾ | 0.45 |
| Desmodur ® T 80⁵⁾ | 50.0 |

1) Polyol 1: Voranol ® CP 3322 available from Dow Chemical, this is a glycerol-based polyether polyol having an OH number of 48 mg KOH/g and predominantly secondary OH groups, average molar mass = 3500 g/mol.
2) KOSMOS ® T9, available from Evonik Industries: tin(II) salt of 2-ethylhexanoic acid.
3) TEGOAMIN ® DMEA: dimethylethanolamine, available from Evonik Industries. Amine catalyst for production of polyurethane foams.
4) Foam stabilizer: non-inventive polyether-modified polysiloxane or inventive polyether-modified polysiloxanes, according to formula (1). The polyether-modified polysiloxanes were obtained by the following synthesis procedures:

### Foam Stabilizer 1 (Non-Inventive):

A 1 three-neck flask having a jacketed coil condenser and precision glass stirrer was initially charged with 225 g of a siloxane of the general formula [Me₃SiO_{1/2}]₂ [SiMe₂O_{2/2}]₇₀[SiMeHO_{2/2}]₄ together with 289 g of an allyl functional polyether of the general formula CH₂═CHCH₂—O— [C₂H₄O]₃₇—[C₃H₆O]₃₈—Me and 87 g of a allyl polyether of the general formula CH₂═CHCH₂—O— [C₂H₄O]₁₄—Me. The mixture was stirred and heated to 90° C. Then 0.3 g of a solution of the Karstedt catalyst in toluene (w (Pt)=2%) was added. An exothermic reaction set in. The reaction mixture was then stirred at 90° C. for four hours. After this reaction time, the SiH functions had been fully converted.

### GPC Results

Mₙ: 6197 g/mol, M_{w}: 16690 g/mol, M_{w}/Mₙ: 2.69, content (RI)<100 000 g/mol: 99.9%.

### Foam Stabilizer 2 (Inventive):

A 1 l three-neck flask having a jacketed coil condenser and precision glass stirrer was initially charged with 238 g of a siloxane of the general formula [Me₃SiO_{1/2}]₂ [SiMe₂O_{2/2}]₇₀[SiMeHO_{2/2}]₄ together with 278 g of an allyl functional polyether of the general formula CH₂═CHCH₂—O— [C₂H₄O]₃₇—[C₃H₆O]₃₈—Me, 82 g of a allyl polyether of the general formula CH₂═CHCH₂—O— [C₂H₄O]₁₄—Me and 1.2 g 1,7-Octadiene. The mixture was stirred and heated to 90° C. Then 0.3 g of a solution of the Karstedt catalyst in toluene (w (Pt)=2%) was added. An exothermic reaction set in. The reaction mixture was then stirred at 90° C. for four hours. After this reaction time, the SiH functions had been fully converted.

### GPC Results

Mₙ: 6298 g/mol, M_{w}: 25216 g/mol, M_{w}/Mₙ: 4.00, content (RI)<100 000 g/mol: 95.2%.

### Foam Stabilizer 3 (Inventive):

A 1 l three-neck flask having a jacketed coil condenser and precision glass stirrer was initially charged with 238 g of a siloxane of the general formula [Me₃SiO_{1/2}]₂ [SiMe₂O_{2/2}]₇₀[SiMeHO_{2/2}]₄ together with 278 g of an allyl functional polyether of the general formula CH₂═CHCH₂—O— [C₂H₄O]₃₇— [C₃H₆O]₃₈—Me, 82 g of a allyl polyether of the general formula CH₂═CHCH₂—O— [C₂H₄O]₁₄—Me and 2.3 g Trimethylolpropane Diallyl Ether 90 from Perstorp (CAS Number-682-09-7). The mixture was stirred and heated to 90° C. Then 0.3 g of a solution of the Karstedt catalyst in toluene (w (Pt)=2%) was added. An exothermic reaction set in. The reaction mixture was then stirred at 90° C. for four hours. After this reaction time, the SiH functions had been fully converted.

### GPC Results

Mₙ: 6341 g/mol, M_{w}: 20887 g/mol, M_{w}/Mₙ: 3.29, content (RI)<100 000 g/mol: 98.0%.

### Foam Stabilizer 4 (Inventive):

A 1 l three-neck flask having a jacketed coil condenser and precision glass stirrer was initially charged with 238 g of a siloxane of the general formula [Me₃SiO_{1/2}]₂ [SiMe₂O_{2/2}]₇₀[SiMeHO_{2/2}]₄ together with 278 g of an allyl functional polyether of the general formula CH₂═CHCH₂—O— [C₂H₄O]₃₇—[C₃H₆O]₃₈—Me, 82 g of a allyl polyether of the general formula CH₂═CHCH₂—O— [C₂H₄O]₁₄—Me and 2.0 g 1,1,3,3-Tetramethyl-1,3-divinyl-disiloxan (CAS Number: 2627-95-4). The mixture was stirred and heated to 90° C. Then 0.3 g of a solution of the Karstedt catalyst in toluene (w (Pt)=2%) was added. An exothermic reaction set in. The reaction mixture was then stirred at 90° C. for four hours. After this reaction time, the SiH functions had been fully converted.

### GPC Results

Mₙ: 6373 g/mol, M_{w}: 24371 g/mol, M_{w}/Mₙ: 3.82, content (RI)<100 000 g/mol: 95.7%.

⁵⁾ tolylene diisocyanate T 80 (80% 2,4 isomer, 20% 2,6 isomer) from Covestro, 3 mPa-s, 48% NCO, functionality 2.

400 g of polyol was used in each foaming operation; the other formulation constituents were recalculated accordingly. 1.00 part of a component denoted 1.00 g of this substance per 100 g of polyol for example.

The foaming was carried out by what is called manual mixing. Formulation 1 as specified in table 1 was used. To this end, a paper cup was charged with polyol, the respective amine catalyst mixture, the tin catalyst tin(II) 2-ethylhexanoate, water and a foam stabilizer, and the contents were mixed at 1000 rpm for 60 seconds with a disc stirrer. After the first stirring the isocyanate (TDI) was added to the reaction mixture and stirred at 2500 rpm for 7 s and then immediately transferred into a paper-lined box (30 cm×30 cm base area and 30 cm height). After being poured in, the foam rose in the foaming box. In the ideal case, the foam blew off on attainment of the maximum rise height and then fell back slightly. This opened the cell membranes of the foam bubbles and an open-pore cell structure of the foam was obtained. To assess the properties, the following characteristic parameters were determined: rise time, rise height and settling of the foam after the end of the rise phase.

Defined foam bodies were cut out of the resulting hot-cure flexible PU foam blocks and were analysed further. The following physical properties were determined on the test specimens: cell count, porosity by the air flow method, foam density (FD) and rolling deformation at room temperature.

The results of the influence of the compounds according to the invention regarding foaming and the physical properties of the resulting hot-cure flexible PU foams are compiled in the following tables. Hot-cure flexible PU foams were produced with a standard flexible foam stabilizer (foam stabilizer 1) and with the inventive flexible foam stabilizers 2, 3 and 4.

TABLE 2
Reference foams (obtained using foam stabilizer 1) and foams with foam stabilizer 2.

| | #1 | #2 | #3 | | | |
|---|---|---|---|---|---|---|
| | Foam | Foam | Foam | | | |
| | stabilizer 1 | stabilizer 1 | stabilizer 1 | #4 | #5 | #6 |
| | (non- | (non | (non | Foam | Foam | Foam |
| | inventive) | inventive) | inventive) | stabilizer 2 | stabilizer 2 | stabilizer 2 |
| Amount of Sn | 0.20 pphp | 0.24 pphp | 0.28 pphp | 0.20 pphp | 0.24 pphp | 0.28 pphp |
| catalyst | | | | | | |
| Amount of | 0.45 pphp | 0.45 pphp | 0.45 pphp | 0.45 pphp | 0.45 pphp | 0.45 pphp |
| stabilizer | | | | | | |
| Rise time (s) | 108 | 99 | 91 | 109 | 99 | 92 |
| Rise height | 33.8 | 34.4 | 36.8 | 34.3 | 34.4 | 35.2 |
| (cm) | | | | | | |
| Settling (cm) | −0.5 | −0.2 | 0.0 | −0.2 | −0.1 | 0.0 |
| Cells (per cm) | 13 | 13 | 13 | 13 | 13 | 13 |
| Density | 23.6 | 23.1 | 22.8 | 23.4 | 23.1 | 22.5 |
| (kg/m³) | | | | | | |
| Porosity | 3.58 | 2.23 | 1.37 | 3.12 | 2.01 | 1.67 |
| (SCFM) | | | | | | |
| Roll | + | − − | − − − | + + + | + | − |
| deformation | | | | | | |
| (7 d, 21° C.) | | | | | | |

TABLE 3
Foams with foam stabilizers 3 and 4.

| | #7 | #8 | #9 | #10 | #11 | #12 |
|---|---|---|---|---|---|---|
| | Foam | Foam | Foam | Foam | Foam | Foam |
| | stabilizer 3 | stabilizer 3 | stabilizer 3 | stabilizer 4 | stabilizer 4 | stabilizer 4 |
| Amount of Sn | 0.20 pphp | 0.24 pphp | 0.28 pphp | 0.20 pphp | 0.24 pphp | 0.28 pphp |
| catalyst | | | | | | |
| Amount of | 0.45 pphp | 0.45 pphp | 0.45 pphp | 0.45 pphp | 0.45 pphp | 0.45 pphp |
| stabilizer | | | | | | |
| Rise time (s) | 108 | 99 | 92 | 108 | 98 | 92 |
| Rise height | 33.5 | 34.9 | 36.2 | 34.1 | 34.3 | 35.6 |
| (cm) | | | | | | |
| Settling (cm) | −0.2 | 0.0 | 0.0 | −0.2 | −0.1 | 0.0 |
| Cells (per cm) | 13 | 13 | 13 | 13 | 13 | 13 |
| Density | 23.5 | 23.2 | 22.9 | 23.1 | 23.0 | 22.4 |
| (kg/m³) | | | | | | |
| Porosity | 3.20 | 2.12 | 1.45 | 3.35 | 2.08 | 1.75 |
| (SCFM) | | | | | | |
| Roll | + + + | 0 | − | + + + | 0 | 0 |
| deformation | | | | | | |
| (7 d, 21° C.) | | | | | | |

In the evaluation of the results, it must be taken into account that the result of the rolling test depends significantly on the porosity of the foam. For foams having a more closed cell structure generally worse results are obtained than for those foams those having an open cell structure. To obtain complete information about the rolling deformation test performance of the inventive foam stabilizers the screening was performed after adjustment of the foam porosity to different levels. This was achieved by variation of the use level of tin catalyst (KOSMOS® T9) between 0.20 and 0.28 pphp. Foams obtained using the same use level of tin catalyst were compared with each other.

While the usage of the inventive foam stabilizers 2, 3 and 4 does not show any significant impact on general foam properties like porosity, cell structure or hardness, compared to the non-inventive foam stabilizer 1, it was surprisingly found that the foams obtained using the inventive foam stabilizers show significantly improved results in the recovery after compression over the whole investigated porosity range, as tested by the rolling test. The recovery of the original shape of the test specimens after rolling deformation was improved to a quite crucial degree when comparing foams with similar porosities: e.g. foam #1 and foam #4 were both obtained using 0.20 pphp KOSMOS® T9 and show comparable foam properties, but while foam #1 (using non-inventive foam stabilizer 1) was rated with +in the rolling test (recovery of original sample height, but remaining indentations and grooves after 10 minutes), foam #4 using the inventive foam stabilizer 2 was surprisingly rated significantly better as +++(fully recovered after less than 5 minutes). This improvement stands for a significantly better recovery of the rolled and compressed foam samples. The same significant improvement is also found for the tighter foams obtained using a higher level of KOSMOS® T9 and for the foams obtained using foams stabilizers 3 and 4.

The hot-cure flexible PU foams according to the invention are also found to have low emissions. This can be seen in the VOC tests according to DIN EN ISO 16000-9:2008-04. It is found here, in a low-emissions formulation, that total emissions are well below the typical limits for TVOC of 500 μg/m³. The hot-cure flexible PU foams according to the invention are also suitable to meet the requirements of the VOC and FOG tests according to VDA 278. It is found here, in a low-emissions formulation, that the total emissions found in the VOC and FOG are not increased compared to the reference foams and well below the typical limits for the VOC (100 μg/g) and FOG (250 μg/g) values. The foam stabilizers 2, 3 and 4 are thus also highly suitable for use in low-emissions formulations. The results are summarized in table 4.

TABLE 4
Results of chamber tests according to DIN EN ISO 16000-9: 2008-04
and VDA 278 for a reference hot-cure flexible PU foam obtained
using foam stabilizer 1 and a foam using the inventive foam
stabilizer 2 based on a low emission formulation.

| Method | Foam stabilizer | TVOC | |
|---|---|---|---|
| DIN EN ISO | Foam stabilizer 1 | 20 | μg/m³ |
| 16000-9: 2008-04 | (non-inventive) | | |
| | Foam stabilizer 2 | 21 | μg/m³ |
| VDA 278 (VOC) | Foam stabilizer 1 | <10 | μg/g |
| | (non-inventive) | | |
| | Foam stabilizer 2 | <10 | μg/g |
| VDA 278 (FOG) | Foam stabilizer 1 | 22 | μg/g |
| | (non-inventive) | | |
| | Foam stabilizer 2 | 17 | μg/g |

The overall advantageousness of the invention has also been confirmed in the case of viscoelastic and hypersoft flexible foams.

1. A shaped flexible hot-cure PU foam article, obtained by a process comprising reacting a mixture comprising a polyol component and a isocyanate component in the presence of a component comprising a blowing agent, a catalyst suitable to catalyze an isocyanate-polyol and/or isocyanate-water reactions and/or isocyanate trimerization, a foam stabilizer, and optionally, a further additive,
wherein the foam stabilizer comprises a compound of formula (1):
[R¹₂R²SiO_{1/2}]ₐ[R¹₃SiO_{1/2}]_{b}[R¹₂SiO_{2/2}]_{c}[R¹R²SiO_{2/2}]_{d}[R³SiO_{3/2}]ₑ[SiO_{4/2}]_{f}G_{g} (1),
wherein
a is in a range of from 0 to 12,
b is in a range of from 0 to 8,
c is in a range of from 15 to 300,
d is in a range of from 0 to 40,
e is in a range of from 0 to 10,
f is in a range of from 0 to 5,
g is in a range of from greater than 0 to 3,
a+b+c+d+e+f+g>23,
a+b≥2,
a+d≥1
wherein G is independently a bridging group of formula (2) 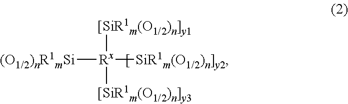
wherein
R^{x} is independently a linear organic, branched organic, an Si containing radical,
m is independently 1 or 2,
n is independently 1 or 2,
n+m=3,
y1, y2, and y3 are independently 0 or 1,
y1+y2+y3>0 to 3,
wherein
R¹ is independently a C1 to C16 alkyl radical, C6 to C16 aryl radical, H,
R² is independently a polyether of formula (3), obtained by polymerizing at least one alkylene oxide, or an organic radical of formula (4)
—R⁴—O—[C₂H₄O]ᵢ—[C₃H₆O]ⱼ—[CR⁶₂CR⁶₂O]ₖ—R⁷ (3),
—Oₕ—R⁸ (4),
wherein
h is 0 or 1,
i is in a range of from 0 to 150,
j is in a range of from 0 to 150,
k is in a range of from 0 to 80,
p in a range of from 1 to 18,
i+j+k≥3,
R³ is independently an alkyl radical or aryl radicals, either or which is optionally substituted with one or more hetero atoms,
R⁴ is a divalent organic radical,
R⁵ is independently a C1 to C16 alkyl radical or C6 to C16 aryl radical,
R⁶ is independently a C1 to C16 alkyl radical, optionally comprising an ether or halogen substitution, a C6 to C18 aryl radical, optionally comprising an ether, or H,
R⁷ is independently H, alkyl, —C(O)—R⁹, —C(O)O—R⁹ or —C(O)NHR⁹, optionally comprising a hetero atom substitution,
R⁸ is independently an alkyl radical or aryl radical, optionally comprising an OH, ether, epoxide, ester, amine or/and halogen,
R⁹ is independently a C1 to C16 alkyl radical or C6 to C16 aryl radical.

2. The article of claim 1, which is a standard flexible PU foam, a viscoelastic PU foam, or a hypersoft PU foam.

3. The article of claim 1, in the form of a shaped article having a height in a range of from 1 cm to 50 cm and a width in a range of from 20 cm to 300 cm.

4. The article of claim 1, which, based on its starting volume, is compressed by at least 20°% and kept in compressed form by an auxiliary.

5. The article of claim 1, which is in a compressed state.

6. The article of claim 1, comprising the compound of formula (1) in a total in a range of from 0.05 to 3.0 wt. %, based on an entire flexible hot-cure PU foam weight.

7. The article of claim 1, obtained using one or more recycled polyols.

8. The article of claim 1, wherein the compound of formula (1) comprises at least 1 wt. % of high molecular weight product proportion with a molecular weight of ≥100 000 g/mol, determined by gel permeation chromatography.

9. The article of claim 1, wherein the compound of formula (1) is made by catalyzed addition reaction of a siloxane comprising a silane hydrogen atom with a linear polyoxyalkylene oxide polyether,
wherein a linear chain of the linear polyoxyalkylene oxide polyether is blocked at one end by an alkyleneoxy group and bears a hydrogen atom or has been capped.

10. The article linear polyoxyalkylene oxide polyether, wherein G comprises a (O1/2)ₙSiR¹ₘ-groups that is connected by an organic or Si-comprising radical, and when a difunctional crosslinker is used, G is independently (i), (ii), or (iii)
(O_{1/2})ₙSiR¹ₘ—CH₂CHR¹⁰—R¹¹—CHR¹⁰CH₂—SiR¹ₘ(O_{1/2})ₙ (i)
(O_{1/2})ₙSiR¹ₘ—CH₂CHR¹⁰—R¹¹—CR¹⁰═CH₂ (ii)
(O_{1/2})ₙSiR¹ₘ—CH₂CHR¹⁰—R¹¹—CR¹⁰═CR¹⁰—CH₃ (iii)
with the proviso that the radical (i) is present,
wherein
R¹⁰ is independently a C1 to C16 alkyl radical, C6 to C16 aryl radical or H,
R¹¹ is independently a divalent organic radicals, optionally comprising an ether, ester, or amide interruption and optionally comprising an OH or (—SiR¹₂O—)ₓSiR¹₂,
x is in a range of from 1 to 50.

11. A process of improving dimensional recovery of a shaped flexible hot-cure PU foam article after compression over a period of at least 20 hours, the method comprising polymerizing components of the shaped flexible hot-cure PU foam article of claim 1 to obtain the shaped flexible hot-cure PU foam article.

12. A process for storing and/or transporting a shaped flexible hot-cure PU foam article, the process comprising:
(a) reacting at least one polyol and at least one isocyanate to form the shaped flexible hot-cure PU foam article of claim 1;
(b) optionally, further processing the shaped flexible hot-cure PU foam article; and
(c) finally, compressing the shaped flexible hot-cure PU foam article by at least 20%, optionally vacuum packing and keeping in compressed form by an auxiliary.

13. The process of claim 12, further comprising:
adding a sufficient amount of compound(s) of formula (1) in the reacting (a) so that a mass proportion of the compound(s) of formula (1) in a finished polyurethane foam is in a range of from 0.05 to 3.0 wt. %.

14. A process for producing a flexible hot-cure polyurethane foam of claim 1, the process comprising:
reacting a mixture comprising a polyol component and a isocyanate component in the presence of a component comprising a blowing agent, a catalyst suitable to catalyze an isocyanate-polyol and/or isocyanate-water reactions and/or isocyanate trimerization, a foam stabilizer, and optionally, a further additive,
wherein the foam stabilizer comprises a compound of formula (1):
[R¹₂R²SiO_{1/2}]ₐ[R¹₃SiO_{1/2}]_{b}[R¹₂SiO_{2/2}]_{c}[R¹R²SiO_{2/2}]_{d}[R³SiO_{3/2}]ₑ[SiO_{4/2}]_{f}G_{g} (1),
wherein
a is in a range of from 0 to 12, b is in a range of from 0 to 8,
c is in a range of from 15 to 300,
d is in a range of from 0 to 40,
e is in a range of from 0 to 10,
f is in a range of from 0 to 5,
g is in a range of from greater than 0 to 3,
a+b+c+d+e+f+g>23,
a+b≥2,
a+d≥1,
wherein G is independently a bridging group of formula (2) 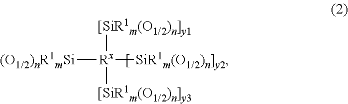
wherein
R^{x} is independently a linear organic, branched organic, or an Si containing radical,
m is independently 1 or 2,
n is independently 1 or 2,
n+m=3,
y1, y2, and y3 are independently 0 or 1,
y1+y2+y3>0 to 3,
wherein
R¹ is independently a C1 to C16 alkyl radical, C6 to C16 aryl radical, H, or —OR⁵,
R² is independently a polyether of formula (3), obtained by polymerizing at least one alkylene oxide, or an organic radical of formula (4)
—R⁴—O—[C₂H₄O]ᵢ—[C₃H₆O]ⱼ—[CR⁶CR⁶₂O]ₖ—R⁷ (3),
—Oₕ—R⁸ (4),
wherein
h is 0 or 1,
i is in a range of from 0 to 150,
j is in a range of from 0 to 150,
k is in a range of from 0 to 80,
p in a range of from 1 to 18,
i+j+k≥3,
R³ is independently an alkyl radical or aryl radicals, either or which is optionally substituted with one or more hetero atoms,
R⁴ is a divalent organic radical,
R⁵ is independently a C1 to C16 alkyl radical or C6 to C16 aryl radical,
R⁶ is independently a C1 to C16 alkyl radical, optionally comprising an ether or halogen substitution, a C6 to C18 aryl radical, optionally comprising an ether, or H,
R⁷ is independently H, alkyl, —C(O)—R⁹, —C(O)O—R⁹ or —C(O)NHR⁹, optionally comprising a hetero atom substitution,
R⁸ is independently an alkyl radical or aryl radical, optionally comprising an OH, ether, epoxide, ester, amine or/and halogen,
R⁹ is independently a C1 to C16alkyl radical or C6 to C16 aryl radical.

15. A flexible hot-cure polyurethane foam, obtainable by the process of claim 14.

16. A mattress or cushion comprising the flexible hot-cure PU foam of claim 14.

17. The article of claim 1, which is a mattress.

18. The article of claim 1, which is a cushion.

19. The article of claim 1, wherein, in the compound of formula (1), a+b+c+d+e+f+g>40.
